(19) United States
(12) Patent Application Publication
(10) Pub. No.: US 2024/0141196 A1
(43) Pub. Date: May 2, 2024

(54) ACRYLIC COATING COMPOSITIONS FOR BEVERAGE CAN ENDS, BEVERAGE CANS, AND METHODS

(71) Applicant: SWIMC LLC, Cleveland, OH (US)

(72) Inventors: Matthieu ANDRIOT, Attignat (FR); Daphné VIOLEAU, Saint-Étienne-de-Montluc (FR); Cyril DURANTON, Tournus (FR); Sébastien GIBANEL, Givry (FR); Marie BRAILLON-GIRARD, Tournus (FR)

(21) Appl. No.: 18/393,323

(22) Filed: Dec. 21, 2023

Related U.S. Application Data
(63) Continuation-in-part of application No. PCT/US2023/017881, filed on Apr. 7, 2023.
(60) Provisional application No. 63/362,707, filed on Apr. 8, 2022.

(51) Int. Cl. C09D 133/06; B65D 25/14; B65D 25/34; C09D 5/02; C09D 5/03; C09D 7/20

(52) U.S. Cl. CPC C09D 133/064; B65D 25/14; B65D 25/34; C09D 5/022; C09D 5/03; C09D 7/20

(57) ABSTRACT

Acrylic coating compositions for beverage can ends, particularly easy open beverage can ends, beverage cans, and methods of coating. The beverage cans include a metal substrate that is at least partially coated with a coating prepared from the acrylic coating composition. The composition includes an acrylic latex, a crosslinker, and optionally a lubricant.

CROSS-REFERENCE TO RELATED APPLICATIONS

This application is a Continuation-in-Part of International Application Serial No. PCT/US2023/017881, filed 7 Apr. 2023, which claims the benefit of U.S. Provisional Application No. 63/362,707, filed 8 Apr. 2022, the disclosure of each of which is incorporated by reference herein in its entirety.

### BACKGROUND

Beverage can ends, such as easy open can ends, are often the most challenging coating application in the beverage container coating industry. In some instances, this challenge is due to the severe level of fabrication a coating and substrate must endure in formation of the beverage can end. For instance, beverage can ends are formed by first applying the coating composition to a flat metal coil (typically aluminum or steel coil), typically under a high-speed application process with short cure times. The beverage can end is then stamped from the coated metal coil. If an easy open can is desired, a rivet to which a pull tab is attached is also formed from the substrate and such rivet has a very severe contour.

Many packaging coatings (including many coatings suitable for use on the sidewalls of beverage containers) do not possess the toughness and flexibility to accommodate the stamping process used to form the can end and/or the rivet, while still exhibiting sufficient corrosion resistance for the end use at the same time. With prior coatings, there was typically a tradeoff between the flexibility/toughness and the corrosion resistance of a coating. That is, one type of coating composition may have been sufficiently flexible to accommodate the stamping and rivet formation, but such performance came at the expense of corrosion resistance.

Not only are flexibility, toughness, and corrosion resistance needed for coating compositions when hardened to perform in the demanding end use of beverage can ends, such coating compositions should preferably be capable of high-speed application to the substrate. The composition and hardened coating should also be safe for food contact, have good adhesion to the substrate, and resist degradation over long periods of time, even when exposed to harsh environments. Many current packaging coatings suffer from one or more performance defects and/or contain extractable quantities of one or more undesirable compounds particularly when the coatings are exposed to short cure times.

Prior coatings to achieve the high level of performance required for beverage can ends were often bisphenol A-based (BPA) and/or epoxy-based compositions combined with melamine or phenolic crosslinkers. The melamine and phenolic resins were based on formaldehyde monomers. In addition, in latexes, historically both styrene and glycidyl methacrylate (GMA) have been used, e.g., for internal crosslinking and other special properties in the packaging industry. Such components are becoming less desired in the packaging field for a variety of reasons. However, non-epoxy and non-formaldehyde alternatives tend to have shortcomings in terms of processing and/or performance when used in the context of coating operations for beverage can ends.

Acrylic-based coatings are one alternative to epoxy coatings. Acrylic-based coating compositions have been used as spray coatings for the interior body of food or beverage containers; however, when prior acrylic-based compositions are used in the harsh and challenging fabrication of beverage can ends subjected to short cure times, the curing process and prior acrylic chemistry tends to fall short of performance expectations. Also, historically acrylic-based coatings have not been sufficiently flexible, tough, and corrosion resistant.

### BRIEF DESCRIPTION OF THE FIGURES

FIG. 1 is a schematic view of a coil substrate coating line suitable for applying the liquid polymeric coating composition of this disclosure.

FIGS. 3 to 6 are exemplary plan and perspective views of a metal sheet having simulated tabs formed thereon for feathering evaluation as described in the Examples.

### SUMMARY

The present disclosure provides a coating composition (which may be an aqueous coating composition or powder coating composition in an alternative embodiment) suitable for a beverage can end, preferably an easy open end of a beverage can. The coating composition includes an acrylic latex, and a carboxyl-reactive, nitrogen-containing crosslinker that is not derived from formaldehyde. In preferred embodiments, the acrylic copolymer includes acid (preferably carboxylic acid) or anhydride groups, some or all of which may be neutralized with base.

In one embodiment, a beverage can end coil coating composition including: an acid- or anhydride-functional acrylic latex comprising an emulsion polymerized polymer; a carboxyl-reactive crosslinker that is nitrogen-containing and is not derived from formaldehyde; and optionally, a lubricant. The coating composition: (i) includes less than 2 wt-%, by weight of total solids, of a crosslinker derived from formaldehyde, if any; (ii) is free of bisphenol A, bisphenol F, and bisphenol S; (iii) is optionally free of styrene; (iv) has a class transition temperature (Tg), as determined by Differential Scanning Calorimetry (DSC), when applied to a cleaned and chrome-free, zirconium-pretreated aluminum panel and cured for 12 seconds to a peak metal temperature of 249° C. to achieve a dried film thickness of approximately 11 (i.e., 10-12) grams per square meter, of 10° C. to 50° C.; and (v) when applied to a cleaned and chrome-free, zirconium-pretreated aluminum panel and cured for 12 seconds to a peak metal temperature of 249° C. to achieve a dried film thickness of approximately 11 (i.e., 10-12) grams per square meter and formed into a fully converted (typically, 206) standard opening beverage can end, passes less than 5 milliamps of current, while being exposed for 4 seconds to an electrolyte solution containing 1% by weight of NaCl dissolved in deionized water.

In another embodiment, a method is provided that includes: providing a coating composition described herein; applying the coating composition (e.g., via roll coating) to a substrate comprising a beverage can end steel or aluminum coil; heating the coated substrate in an oven for 6 to 30 seconds, preferably 8 to 15 seconds, of oven residence time to achieve a peak metal temperature of 200° C. to 260° C.; and optionally fabricating (e.g., stamping) the coated coil to form an easy open beverage can end. Preferably, in this method, applying coating composition to the surface of the substrate includes applying the coating composition on a continuously moving surface traveling at a line speed of 50 meters per minute to 400 meters per minute.

In yet another embodiment, a coated article is provided that includes a beverage can end having an interior or exterior coating, or both formed from the coating composition described herein, or resulting from the method described herein. In yet further aspects or embodiments, an article is described herein wherein the article includes a metal substrate having a riveted beverage can end with a coating disposed on at least a portion of the riveted beverage can end, wherein the coating is formed from the aqueous coating composition described herein.

### Definitions

The term “easy open end” refers to a can end (typically an end of a beverage can) that includes (i) a frangible opening portion (which for some beverage can ends functions as a drinking spout) and (ii) a riveted portion for attaching a pull tab thereto for purposes of opening the frangible opening portion to access the product housed within a can or container.

The term “chrome-free” means free of chromium. Historically, pretreatments of aluminum panels used for beverage cans were based on chromium 6 or chromium 3. Neither are used herein.

The term “food-contact surface” refers to a surface of an article (e.g., a beverage can) that is in contact with, or intended for contact with, a food or beverage product.

The term “organo” or “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds.

The term “water-dispersible” in the context of a water-dispersible polymer means that the polymer can be mixed into water (or an aqueous carrier) to form a stable mixture. For example, a mixture that readily separates into immiscible layers is not a stable mixture. The term “water-dispersible” is intended to include the term “water-soluble.” In other words, by definition, a water-soluble polymeris also considered to be a water-dispersible polymer. As used herein, “water-dispersible” means the component (polymer component, for instance) does not visibly separate after 4 months at room temperature (25° C.) or 1 month at elevated temperatures (40° C.).

The term “dispersion” in the context of a dispersible polymer refers to the mixture of a dispersible polymer and a carrier fluid. The term “dispersion” is intended to include the term “solution.”

A group that may be the same or different is referred to as being “independently” something. Substitution is anticipated on the organic groups of the compounds of the present invention. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, for example, “alkyl group” includes ether groups, haloalkyls, nitroalkyls, carboxyalkyls, hydroxyalkyls, sulfoalkyls, etc.

As used herein, “acrylic latex” mean a dispersion of polymer particles (prepared from ethylenically unsaturated monomers that include (meth)acrylic acid and/or (meth)acrylate monomers) in water.

As used herein, “(meth)acrylate” is a shorthand reference to acrylate, methacrylate, or combinations thereof, and “(meth)acrylic” is a shorthand reference to acrylic, methacrylic, or combinations thereof.

As used herein, “crosslinker” refers to molecule capable of forming a covalent linkage between polymers or between two different regions of the same polymer.

As used herein, the terms “polymer” and “copolymer” are interchangeable and may refer to a homopolymer that is formed from repeating units of one structural unit or monomer as well as a copolymer that may be formed from different types of structural units or monomers.

As used herein, “monomer” or reactant generally refers to a compound within a reaction mixture prior to polymerization and monomer units or (alternatively) repeating units or structural units refers to the monomer or reactant within the polymer. Preferably, the various monomers or reactants herein are randomly polymerized monomer units, structural units, or repeating units. If the discussion herein refers to a monomer or reactant, it also implies the resultant monomer unit, structural unit, or repeating unit thereof in the polymer. Likewise, if the discussion refers to a monomer unit, structural unit, or repeating unit, it also implies the monomer or reactant mixture used to form the polymer with the associated units therein.

As used herein, the term “substantially free” when used with respect to a composition that may contain a particular compound means that the composition contains less than 1,000 parts per million (ppm) of the recited compound regardless of the context of the compound in the composition (e.g., regardless of whether the compound is present in unreacted form, in reacted form as a structural unit of another material, or a combination thereof). The term “completely free” when used with respect to a composition that may contain a particular compound means that the composition contains less than 100 parts per million (ppm) of the recited compound regardless of the context of the compound in the composition (e.g., regardless of whether the compound is present in unreacted form, in reacted form as a structural unit of another material, or a combination thereof). As will be appreciated by persons having ordinary skill in the art, the amount of a compound in an ingredient, polymer, formulation or other component typically may he calculated based on the amounts of starting materials employed and yields obtained when making such ingredient, polymer, formulation or other component.

When the phrases “free,” “free of” (outside the context of the aforementioned phrases), “do not contain,” “does not contain,” “does not include any,” and the like, are used. herein, such phrases are not intended to preclude the presence of trace amounts of the pertinent structure or compound which may be present but were not intentionally used, e.g., the presence of environmental contaminants.

The term “epoxy-free,” when used herein in the context of a polymer, refers to a polymer that does not include any “epoxy backbone segments” (viz., segments formed from reaction of an epoxy group and a group reactive with an epoxy group). By way of example, a polymer made from ingredients including an epoxy resin would not he considered epoxy-free. Similarly, a polymer having backbone segments that are the reaction product of a bisphenol (e.g., bisphenol A, bisphenol F, bisphenol S, 4,4′dihydroxy bisphenol, etc.) and a halohydrin (e.g., epichlorohydrin) would not be considered epoxy-free. However, a vinyl polymer formed from vinyl monomers or oligomers that include a pendant epoxy moiety glycidyl methacrylate) would be considered epoxy-free because the vinyl polymer would be free of epoxy backbone segments. Coating compositions that are referred to as “epoxy-free” are not made using any polymers or other material having epoxy backbone segments.

“Feathering” is a term used to describe the adhesion loss of a coating on the tab of a beverage can end, When a beverage can is opened, a portion of free film may be present across the opening of the container or can if the coating loses adhesion on the tab, Such portion of free film is considered feathering.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “comprises” and variations thereof do not have a limiting meaning where these terms appear in the description and claims. As used herein, “a,” “an,” “the,” “at least one,” and “one or more” are used interchangeably. Thus, for example, a. coating composition that comprises “an” amino crosslinker can be interpreted to mean that the coating composition includes “one or more” amino crosslinkers.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

It is noted that, as used in this specification and the appended claims, the singular forms “a,” “an,” and “the,” include plural referents unless expressly and unequivocally limited to one referent. Thus, for example, reference to “an antioxidant” includes two or more different antioxidants. As used herein, the term “include” and its grammatical variants are intended to be non-limiting, such that recitation of items in a list is not to the exclusion of other like items that can be substituted or added to the listed items

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1 to 4 is to be interpreted as an express disclosure of the values 1, 2, 3, and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent, or parameter.

The above summary and definitions of the present disclosure is not intended to describe each disclosed embodiment or every implementation thereof. The description that follows more particularly exemplifies illustrative embodiments, aspect, or embodiments. In several places throughout the application, guidance is provided through lists of examples, which examples can be used in various combinations. In each instance, the recited list serves only as a representative group and should not be interpreted as an exclusive list.

### DETAILED DESCRIPTION OF ILLUSTRATIVE EMBODIMENTS

The present disclosure provides a coating composition (an aqueous or powder coating composition) for beverage can ends, particularly easy open ends of beverage cans. Thus, the intended for use of such composition is in forming can end coatings, particularly easy open can end coatings, and particularly interior such coatings (e.g., interior coatings on riveted interior steel or aluminum beverage can ends).

In one aspect, the aqueous coating composition is an acrylic-based coating composition that includes an acrylic latex, a carboxyl-reactive crosslinker, and optionally a lubricant. Such aqueous coating composition of the disclosure is a “coil coating composition” because it is applied using a coil coating process. In another aspect, the presort disclosure provides a beverage can that includes a metal substrate thereof having at least a portion thereof coated with the aqueous coil coating composition (or powder coil coating composition). In yet other aspects, the present disclosure provides methods of coil coating a beverage can and/or a metal substrate suitable for the beverage can, and in particular the easy open end of the beverage can. The methods may include forming the aqueous coil coating composition as described herein (or powder coil coating composition described herein) and applying the composition to a metal substrate using coil coating methods.

The compositions herein preferably include a crosslinker, which is preferably derived from ingredients that do not include formaldehyde. Nitrogen-containing carboxyl-reactive crosslinkers are preferred crosslinkers. In preferred embodiments, the crosslinker may be a hydroxyalkylamide crosslinker. Such crosslinkers allow for production of a preferred formaldehyde-free coating composition having sufficient flexibility and corrosion resistance at the same time for use as an interior or exterior coating of a beverage can end including rives (e.g., for attaching a pulltab thereto for purposes of accessing the interior of the can such as, e.g., via a drinking spout). The crosslinker can have any suitable combination of one or more carboxyl-reactive functional groups, and more preferably includes two or more such groups, Hydroxyl groups are preferred carboxyl-reactive groups. In some embodiments, the crosslinker includes two or more, three or more, or four or more hydroxyl groups.

The coil coating compositions herein are suitable for metal substrates and coil coating conditions and application methods, In preferred embodiments, the metal substrate is a metal typically used in the beverage packaging industry. In one embodiment, the metal substrate includes steel, aluminum, or a combination thereof. Preferably, the metal substrate is aluminum, and more preferably a chromium-free, pre-treated aluminum. The metal substrate may be formed into a beverage can end and may include a riveted beverage can end.

The unique combination of the acrylic latex binder system and crosslinker herein enables preferred non-formaldehyde and non-epoxy binder systems to achieve the robust performance needed for beverage can end applications even when using short cure cycles. This unique combination of components, among other features, unexpectedly achieves a high level of product resistance and flexibility at the same time generally required for the internal coating (and in particular the easy open end) of beverage metal packaging. In some embodiments, the performance can be obtained without the need for melamine and/or formaldehyde crosslinkers. In addition, the resulting coating is capable of exhibiting such beneficial coating properties, while also exhibiting excellent feathering properties.

For coil coating applications and beverage can ends, the curing process of the coil coating application is often very short (such as, flash peak metal temperatures of 200° C. to 260° C. (in other embodiments, 230° C., to 260° C.) achieved in 6 seconds to 30 seconds oven cure time, preferably 8 seconds to 20 seconds oven cure time, more preferably, 8 seconds to 15 seconds oven cure time, even more preferably, 8 seconds to 14 seconds oven cure time, and still more preferably, 10 seconds to 12 seconds oven cure time.

Further details of the compositions and methods are provided below.

### Acrylic Latex

The coating composition disclosed herein is an acrylic-based coating composition. Accordingly, the coating composition includes an acrylic latex. The acrylic latex includes polymer particles that are capable of being stably dispersed in water. The acrylic latex is an acid- or anhydride-functional acrylic latex (i.e., a latex that includes a polymer with acid groups, typically carboxylic acid groups, and/or anhydride groups).

The acrylic latex includes an emulsion polymerized polymer, preferably formed from polymerization of an ethylenically unsaturated monomer component including two or more different monomer, and more typically three or more different monomers. Preferably, the acrylic latex is polymerized in water and at least a substantial portion (e.g., at least 50 wt-%, based on the total non-volatile weight, i.e., total solids weight, of the acrylic latex) of the acrylic latex is an emulsion polymerized latex (e.g., the ethylenically unsaturated monomer component is polymerized using an emulsion polymerization process). In certain embodiments, the acrylic latex includes at least 50 wt-%, at least 60 wt-%, at least 70 wt-%, at least 80 wt-%, at least 90 wt-%, at least 95 wt-%, or at least 98 wt-% of an emulsion polymerized polymer, based on the total solid weight of the acrylic latex.

In certain embodiments, the acrylic latex preferably has an acid number of at least 40, greater than 40, at least 50, greater than 50, at least 60, greater than 60, at least 70, greater than 70, at least 80, greater than 80, at least 100, greater than 100, at least 150, or greater than 150 mg KOH per gram of the latex. In certain embodiments, the acid number is no greater than 400, less than 400, no greater than 300, less than 300, no greater than 200, less than 200, no greater than 150, less than 150, no greater than 100, or less than 100 mg KOH per gram of the latex. Acid number (also called acid value or acidity) is the mass of potassium hydroxide (KOH) in milligrams that is required to neutralize one gram of chemical substance. Acid numbers can be measured pursuant to the BS EN ISO 3682-1998 standard. In certain preferred embodiments, the acrylic latex has an acid number of 40 to 150, 50 to 150, 40 to 100, 50 to 100, 60 to 100, or 100 to 200 mg KOH per gram of the latex. Typically, the acid number is provided by the acrylic polymer particles of the acrylic latex as a result of the functionality of the monomers; however, in some embodiments, at least a portion of the acid number is provided by a surfactant (e.g., a polymeric surfactant having carboxylic acid groups).

In certain embodiments, the ethylenically unsaturated monomer component used to make the acrylic latex is a mixture of monomers, more preferably a mixture of monomers that includes at least one (meth)acrylate monomer, and more typically a plurality of (meth)acrylate monomers. In preferred embodiments, the ethylenically unsaturated monomer component used to make the acrylic latex is a mixture of monomers, more preferably a mixture of monomers that includes at least one ethylenically unsaturated acid- or anhydride-functional monomer or salt thereof, and at least one (meth)acrylate monomer, and more typically a plurality of (meth)acrylate monomers. Any combination of one or more (meth)acrylates may be included in the ethylenically unsaturated monomer component optionally in combination with one or more non-(meth)acrylate monomers.

Examples of useful ethylenically unsaturated acid- or anhydride-functional monomers or salts thereof include acids such as, for example, acrylic acid, methacrylic acid, alpha-chloroacrylic acid, alpha-cyanoacrylic acid, crotonic acid, alpha-phenylacrylic acid, beta-actyloxypropionic acid, fumaric acid, maleic acid, sorbic acid, alpha-chlorosorbic acid, angelic acid, cinnamic acid, p-chlorocinnamic acid, beta-stearylacrylic acid, citraconic acid, mesaconic acid, glutaconic acid, aconitic acid, tricarboxyethylene, 2-methyl maleic acid, itaconic acid, 2-methyl itaconic acid, methyleneglutaric acid, salts thereof, or mixtures thereof. Preferred unsaturated acid-functional monomers include acrylic acid, methacrylic acid, crotonic acid, fumaric acid, maleic acid, 2-methyl maleic acid, itaconic acid, 2-methyl itaconic acid, salts thereof, or mixtures thereof. More preferred unsaturated acid-functional monomers include acrylic acid, methacrylic acid, salts thereof, or mixtures thereof.

In preferred embodiments, ethylenically unsaturated acid- or anhydride-functional monomers, including salts thereof, constitute at least 5 wt-%, or at least 10 wt-% of the ethylenically unsaturated monomer component used to make the acrylic latex. In preferred embodiments, ethylenically unsaturated acid- or anhydride-functional monomers, including salts thereof, constitute no more than 20 wt-%, or no more than 15 wt-% of the ethylenically unsaturated monomer component used to make the acrylic latex.

To achieve the desired overall Tg, the ethylenically unsaturated monomer component often includes one or more “low” Tg monomers (e.g., ethyl acrylate, butyl acrylate, and the like) and one or more “high” Tg monomers (e.g., methyl methacrylate, cyclohexyl methacrylate, and the like). In certain embodiments, useful (meth)acrylate monomers (e.g., “high” Tg (meth)acrylate monomers) have a Tg of greater than 50° C., greater than 60° C., greater than 70° C., greater than 80° C., greater than 90° C., or greater than 100° C. Typically, such monomers are cyclic and/or branched (meth)acrylate monomers. Although the upper Tg is not restricted, in some embodiments, useful (meth)acrylate monomers have a Tg of less than 130° C. or less than 120° C. For (meth)acrylate monomers specifically referenced herein, any Tg values provided herein for such monomers should be used for comparison relative to the above Tg thresholds. For a (meth)acrylate monomer not having a reported Tg value herein, in the absence of a reliable Tg value reported by a manufacturer of the monomer, the Tg of the monomer may be determined by making a homopolymer having a number average molecular weight of at least 4,000 and a suitable polydispersity index (e.g., preferably less than 3 and ideally as low as possible) and measuring the Tg of the homopolymer using a suitable procedure such as the procedure included in the test methods section below.

Suitable (meth)acrylate monomers include those having the structure (Formula I):

CH₂═C(R¹)—CO—OR² (I)

wherein R¹ is hydrogen or methyl, and R² is an alkyl group (preferably containing 1 to 22, and more preferably 1 to 16, or 1 to 12, or 1 to 10 carbon atoms), a cycloaliphatic group (preferably containing 4 to 12 carbon atoms, or 6 to 10 carbon atoms), an aryl group (preferably containing 4 to 15 carbon atoms, or 6 to 10 carbon atoms), or a combination thereof.

If desired in Formula (I), R² may optionally be substituted with one or more (e.g., one to three) moieties such as hydroxy, halo, phenyl, and alkoxy, for example. Examples of suitable (meth)acrylates of Formula (I) (including, e.g., suitable alkyl (meth)acrylates) include methyl (meth)acrylate, ethyl (meth)acrylate, propyl (meth)acrylate, isopropyl (meth)acrylate, butyl (meth)acryl ate, isobutyl (meth)acrylate, sec-butyl (meth)acrylate, t-butyl (meth)acrylate, pentyl (meth)acrylate, isoamyl (meth.)acrylate, hexyl (meth)acrylate, 2-ethylhexyl (meth)acrylate, octyl(meth)acrylate, isooctyl (meth)acrylate, nonyl (meth)acrylate, isononyl (meth)acrylate, decyl (meth)actylate, isodecyl (meth)acrylate, tridecyl (meth)acrylate, lauryl (meth)acrylate (also referred to as dodecyl (meth)acrylate), cyclohexyl (meth)acrylate, benzyl (meth)acrylate, phenyl (meth)acrylate, isobornyl (meth)acrylate, norbornene (meth)acrylate, tricyclodecenyl (meth)acrylate, hydroxyethyl (meth)acrylate, hydroxypropyl (meth)acrylate, and the like, substituted variants thereof (e.g., ring substituted variants of benzyl (meth)acrylate or phenyl (meth)acrylate), and isomers and mixtures thereof.

Typically, (meth)acrylate monomers will constitute a substantial portion of the ethylenically unsaturated monomer component (e.g., 50 wt-% or more). In preferred embodiments, (meth)acrylate monomers constitute at least 70 wt-%, at least 80 wt-%, or at least 85 wt-%, of the ethylenically unsaturated monomer component used to make the acrylic latex. In preferred embodiments, (meth)acrylates constitute no more than no more than 95 wt-%, or no more than 90 wt-% of the ethylenically unsaturated monomer component used to make the acrylic latex. If an acid- or anhydride-functional polymeric surfactant is used in a sufficient amount to make the latex, then the ethylenically unsaturated monomer component may include more than 95 wt-% of (meth)acrylates, and even up to 100 wt-% of (meth)acrylates.

In preferred embodiments, the ethylenically unsaturated monomer component includes at least one “linear” alkyl (meth)acrylate monomer of Formula (1) having a linear (e.g., non-branched) alkyl group (preferably, a (C1-C4)alkyl group). Examples of such linear groups include the following moieties: methyl, ethyl, n-propyl, n-butyl, etc. Preferred such monomers include one or more of methyl (meth)acrylate, ethyl (meth)acrylate, n-propyl (meth)acrylate, n-butyl (meth)acrylate, and mixtures thereof. In some embodiments, the ethylenically unsaturated monomer component includes at least 20 wt-%, more preferably at least 30 wt-%, and even more preferably at least 40 wt-% of one or more linear alkyl (meth)acrylates. When present, linear alkyl (meth)acrylates typically constitute no more than 80 wt-%, no more than 70 wt-%, no more than 60 wt-%, or no more than 50 wt-% of the ethylenically unsaturated monomer component.

In some embodiments, an ethylenically unsaturated monomer component used to form the acrylic latex includes at least one cyclic and/or branched (meth)acrylate monomer of Formula (I) having a cyclic and/or branched group, Examples of such groups include the following moieties: isopropyl, isobutyl, sec-butyl, t-butyl, cyclohexyl, polycyclic (e.g. bicyclic or tricyclic), etc. Preferred such monomers include one or more of isopropyl (meth)acrylate, isobutyl (meth)acrylate, sec-butyl (meth)acrylate, t-butyl (meth)acrylate, isoamyl (meth)acrylate, 2-ethylhexyl (meth)acrylate, isooctyl (meth)acrylate, isononyl (meth)acrylate, isodecyl (meth)acrylate, tridecyl (meth)acrylate, cyclohexyl (meth)acrylate, benzyl (meth)acrylate, isobornyl (meth)acrylate, norbornene (meth)acrylate, tricyclodecenyl (meth)acrylate, and mixtures thereof. Preferred such monomers include cyclohexyl (meth)acrylate. In some embodiments, the ethylenically unsaturated monomer component includes at least 10 wt-%, at least 15 wt-%, or at least 20 wt-% of one or more cyclic and/or branched alkyl, (meth)acrylates. When present, cyclic and/or branched alkyl (meth)acrylates typically constitute no more than 50 wt-%, no more than 45 wt-%, no more than 40 wt-%, no more than 35 wt-%, or no more than 30 wt-% of the ethylenically unsaturated monomer component.

One or more multi-ethylenically unsaturated (meth)acrylate monomers may optionally be included in the ethylenically unsaturated monomer component. Often such monomers are used for internal crosslinking of latex particles. Examples of multi-ethylenically unsaturated (meth)acrylates include polyhydric alcohol esters of acrylic acid or methacrylic acid, such as ethanediol di(meth)acrylate, propanediol di(meth)acrylate (e.g., 1,2-propanediol di(meth)acrylate and 1,3-propanediol di(meth)acrylate), butanediol di(meth)acrylate (e.g., 1,3-butanediol di(meth)acrylate and 1,4-butanediol di(meth)acrylate), heptanediol di(meth)acrylate, hexanediol di(meth)acrylate, trimethylolethane tri(meth)acrylate trimethylolpropane tri(meth)acrylate, trimethylolbutane tri(meth)acrylate, trirnethylolheptane tri(meth)acrylate, trimethylolhexane tri(meth)acrylate, tetramethylol methane tetra(meth)acrylate, dipropylene glycol di(meth)acrylate, trimethylol hexane tri(meth)acrylate, pentaerythritol tetra(meth)acrylate, isosorbide di(meth)acrylate, allyl (meth)acrylate, glycerol dimethacrylate, isomers thereof, and mixtures thereof. Examples of multi-ethylenically-unsaturated monomers other than (meth)acrylates include diallyl phthalate, divinylbenzene, divinyltoluene, divinylnaphthalene, and mixtures thereof. In some embodiments, di(meth)acrylates are preferred multi-ethylenically unsaturated monomers. In some embodiments (e.g., certain emulsion polymerized embodiments), the ethylenically unsaturated monomer component includes at least 5 wt-% or at least 10 wt-% of one or more multi-ethylenically unsaturated monomers. If used, such multi-ethylenically unsaturated monomers will typically be included in the ethylenically unsaturated monomer component in an amount of no more than 25 wt-%, no more than 20 wt-%, no more than 15 wt-%, no more than 10 wt-%, or no more than 5 wt-%. In some embodiments, the ethylenically unsaturated, monomer component includes no more than 1 wt-%.

In some embodiments, the ethylenically unsaturated monomer component does not include any multi-ethylenically unsaturated (meth)acrylate monomers, In some embodiments, the ethylenically unsaturated monomer component does not include any multi-functional crosslinking monomers.

The ethylenically unsaturated monomer component may optionally include an oxirane-functional monomer such as, for example, an oxirane-functional alpha, beta-unsaturated monomer. Typically, the monomer is a glycidyl ester of an alpha, beta-unsaturated acid, or anhydride thereof (viz., an oxirane group-containing alpha, beta-ethylenically unsaturated monomer). Examples of suitable monomers containing a glycidyl group are glycidyl (meth)acrylate (viz., glycidyl methacrylate and glycidyl acrylate), mono- and di-glycidyl itaconate, mono- and di-glycidyl maleate, and mono- and di-glycidyl formate. It also is envisioned that allyl glycidyl ether and vinyl glycidyl ether can be used as the oxirane-functional monomer. Preferred oxirane-functional monomers are glycidyl acrylate and glycidyl methacrylate (“GMA”), with GMA being particularly preferred in some embodiments. The ethylenically unsaturated monomer component preferably contains no more than 30 wt-%, no more than 20 wt-%, no more than 10 wt-%, or no more than 9 wt-%, if any, of the oxirane group-containing monomer. The ethylenically unsaturated monomer component may include at least 1 wt-%, at least 2 wt-%, at least 3 wt-%, or at least 5 wt-% of oxirane-group containing monomer.

In some embodiments, the ethylenically unsaturated monomer component does not include glycidyl (meth)acrylate monomers. In some embodiments, the acrylic latex, and preferably the overall coil coating composition is free of glycidyl acrylate and glycidyl methacrylate monomers or structural units derived therefrom. In some embodiments, the ethylenically unsaturated monomer component does not include any monomers having oxirane groups.

The ethylenically unsaturated monomer component may also include any other suitable monomers. For example, suitable other ethylenically unsaturated monomers (e.g., olefinic or vinyl monomers other than (meth)acrylates) may include isoprene, diallylphthalate, conjugated butadiene, vinyl naphthalene, acrylonitrile, (meth)acrylamides acrylamide, methacrylamide, N-isobutoxymethyl acrylamide, N-butoxymethyl acrylamide, etc.), methacrylonitrile, vinyl acetate, vinyl propionate, vinyl butyrate, vinyl stearate, and the like, and variants and mixtures thereof.

In some embodiments, the ethylenically unsaturated monomer component, and preferably the acrylic latex, and more preferably the overall coil coating composition, does not contain any (meth)acrylamide-type monomers (e.g., acrylamides or methacrylamides, N-isobutoxymethyl acrylamide, N-butoxymethyl acrylamide) or structural units derived therefrom.

The ethylenically unsaturated monomer component may optionally include one or more vinyl aromatic compounds, including styrene. If a vinyl aromatic monomer is used, it preferably is not styrene or a substituted styrene. In preferred embodiments, the ethylenically unsaturated monomer component is not intentionally formulated to include styrene.

Suitable vinyl aromatic compounds may include styrene (not preferred in some embodiments), substituted styrene compounds (not preferred in some embodiments), and/or other types of vinyl aromatic compounds (e.g., any of the aryl-group-containing ethylenically unsaturated monomers described herein, including aryl (meth)acrylates such as, e.g., benzyl (meth)acrylate). In some embodiments, the ethylenically unsaturated monomer component includes, if any, less than 20 wt-%, less than 10 wt-%, less than 5 wt-% or less than 1 wt-% of vinyl aromatic compounds.

In some embodiments, the ethylenically unsaturated monomer component used to make the acrylic latex does not include styrene. In some such styrene-free embodiments (or, alternatively, certain “low” styrene embodiments), the ethylenically unsaturated monomer component includes one or more cyclic-group-containing monomers such as, for example, an ethylenically unsaturated monomer including a C4 ring (e.g., a cyclobutane ring), a C5 ring (e.g., a cyclopentane ring), a C6 ring (e.g., a cyclohexane ring), or a polycyclic group (e.g., a bicyclic group or a tricyclic group). Cyclohexane groups, which may optionally include one or more substituents in place of hydrogen, are preferred cyclic groups in some embodiments. Cyclic-group-containing (meth)acrylates are preferred such monomers with cyclohexyl (meth)acrylate being particularly preferred. Suitable branched monomers (e.g., monomers haying branched groups that do not include longer linear chains) may also he used in such styrene-free embodiments in place of styrene. While not intending to be bound by theory, such monomers may be used in place of styrene, or other vinyl aromatic monomers, to provide at least some of the beneficial properties of styrene without using styrene.

In some embodiments, the ethylenically unsaturated monomer component, and preferably the acrylic latex, and more preferably the overall coil coating composition, is substantially free of vinyl aromatic monomers or structural units derived therefrom. In some embodiments, the ethylenically unsaturated monomer component, and preferably the acrylic latex, and more preferably the overall coil coating composition, does not include any vinyl aromatic monomers or structural units derived therefrom. In some embodiments, the acrylic latex (e.g., emulsion polymerized acrylic latex) is substantially free of cyclic-group-containing vinyl monomers (e.g., certain embodiments such as, e.g., certain embodiments when methyl (meth)acrylate is employed).

In some embodiments, the ethylenically unsaturated monomer component, and preferably the acrylic latex, and more preferably the overall coil coating composition, does not include any halogenated monomers, such as chlorinated vinyl monomers, or structural units derived therefrom.

In some embodiments the ethylenically unsaturated monomer component from which the acrylic latex is formed may optionally include one or more adhesion promoting monomers. Examples of such monomer may include certain ethylenically unsaturated monomers having a phosphoric or phosphorus acid group. Examples of such monomers are the PAM-100, PAM-200, and PAM-300 monomers commercially available from Solvay. Such monomers may he used in an amount to achieve the desired result.

In some embodiments the ethylenically unsaturated monomer component from which the acrylic latex is formed may optionally include hydroxy-functional monomers (e.g., hydroxyethyl acrylate (HEA), hydroxyethyl methacrylate (HEMA), hydroxypropyl (meth)acrylate (HPMA), etc.). Typically, the amount of hydroxy-functional monomer will be selected to achieve the desired hydroxyl-functionality. That is, when hydroxyl-functional monomer is used, the acrylic latex may have any suitable hydroxyl number to achieve the desired result.

In some embodiments, the ethylenically unsaturated monomer component used to form the acrylic latex includes (i) at least one of acrylic acid or methacrylic acid, preferably acrylic acid, (ii) at least one of ethyl acrylate or n-butyl acrylate, preferably ethyl acrylate, and (iii) a cyclic or branched monomer, preferably cyclic, more preferably cyclohexyl (meth)acrylate, even more preferably cyclohexyl methacrylate (CHMA).

Any suitable process or materials may be employed in making the acrylic latex. Although the aforementioned monomers may be polymerized by standard free radical polymerization techniques, e.g., using initiators such as azoalkanes, peroxides or peroxy esters, to form the acrylic polymer, at least a portion (e.g., at least 50 wt-%, at least 60 wt-%, at least 70 wt-%, at least 80 wt-%, at least 90 wt-%, at least 95 wt-%) of the acrylic latex is an emulsion polymerized polymer.

The ethylenically unsaturated monomer component is typically emulsion polymerized in the aqueous medium in the presence of at least one surfactant (or emulsifier), which can be polymeric, non-polymeric, or a blend thereof. In embodiments in which one or more surfactants are used to prepare a latex polymer, the surfactant can be an anionic, a cationic or a zwitterionic surfactant, or a mixture thereof, and also preferably includes one or more salt groups. In preferred embodiments, the surfactant includes one or more neutralized acid or anhydride groups. Examples of suitable neutralized acid groups may include carboxylate groups (—COO—), sulfate groups (—OSO₃—), sulfinate groups (—SOO—), sulfonate groups (—SO₂O—), phosphate groups (—OPO₃—), phosphinate groups (—POO—), phosphonate groups (—PO₃—), and combinations thereof.

Anionic surfactants are preferred in some embodiments. Examples of suitable anionic surfactants include any of the following surfactants, which preferably have been at least partially neutralized with a suitable base (e.g., any of the bases disclosed herein): any of the acid- or anhydride-functional polymeric surfactants disclosed herein, dodecylbenzene sulfonic acid, dinonylnaphthalene sulfonic acid, dinonylnaphthylenedisulfonic acid, bis(2-ethylhexyl)sulfosuccinic acid, dioctyl sulfosuccinic acid, sodium lauryl sulfate, sodium dodecyl sulfate, sodium laureth sulfate, fatty acid (ester) sulfonate, polyaryl ether phosphate acid or sulfonate acid, and the like, including mixtures thereof.

In some embodiments, it may be useful to use a surfactant that is a “strong acid” surfactant prior to neutralization.

Although any suitable base may be used to neutralize or partially neutralize polymeric or non-polymeric surfactants to form anionic salt groups, amines are preferred bases, with tertiary amines being particularly preferred. Some examples of suitable tertiary amines are trimethyl amine, dimethylethanol amine (also known as dimethylamino ethanol), methyldiethanol amine, triethanol amine, ethyl methyl ethanol amine, dimethyl ethyl amine, dimethyl propyl amine, dimethyl 3-hydroxy-1-propyl amine, dimethylbenzyl amine, dimethyl 2-hydroxy-1-propyl amine, diethyl methyl amine, dimethyl 1-hydroxy-2-propyl amine, triethyl amine, tributyl amine, N-methyl morpholine, and mixtures thereof. Most preferably triethyl amine or dimethyl ethanol amine is used as the tertiary amine.

Some additional examples of neutralizing bases for forming anionic salt groups include inorganic and organic bases such as sodium hydroxide, potassium hydroxide, lithium hydroxide, ammonium hydroxide, and mixtures thereof.

Some examples of neutralizing compounds for neutralizing base groups present on the surfactant and forming cationic salt groups include organic and inorganic acids such as formic acid, acetic acid, hydrochloric acid, sulfuric acid, and combinations thereof.

Although the surfactant may optionally include one or more ethylenically unsaturated groups (e.g., if the surfactant is a polymerizable non-polymeric surfactant), in some embodiments, the surfactant is a saturated surfactant. By way of example, amine-neutralized dodecylbenzenesulfonic acid is considered to be a saturated surfactant. Although amine-neutralized dodecylbenzenesulfonic acid includes an aryl group that includes carbon-carbon double bonds, it does not include any ethylenically unsaturated groups.

The surfactant can be any suitable type of surfactant and may, for example, be a “lower” molecular-weight surfactant (e.g., a surfactant that is non-polymeric and/or has a number average molecular weight of less than about 1,000 Daltons, more typically less than about 750 Daltons, and even more typically less than about 500 Daltons).

In some embodiments, a polymeric surfactant is used which has, for example, a number average molecular weight greater than about 2,000 Daltons or even greater than about 4,000 Daltons. Examples of suitable polymeric surfactants may include water-dispersible polymers of the acrylic, alkyd, polyester, polyether, polyolefin, or polyurethane type, including copolymers thereof (e.g., polyether-acrylic copolymers), and mixtures thereof. Typically, such water-dispersible polymers include one or more salt groups to facilitate stable dispersion into water. Examples of suitable such polymer salts are disclosed in U.S. Pat. No. 8,092,876 (O'Brien); International Publ. No. WO 2018/013766 (O'Brien et al.) and U.S. Pat. No. 9,404,006 (Li) (which describes the use of certain (poly)ethylene (meth)acrylic acid copolymers).

An example of a specific water-dispersible polymer for use as a “polymeric surfactant” is a “higher” acid number acid-functional polymer (e.g., acid number of at least 40, greater than 40, at least 50, greater than 50, at least 60, greater than 60, at least 70, greater than 70, at least 80, greater than 80 milligrams KOH per gram polymer). In some embodiments, an acrylic polymer having such an acid number is solution polymerized in organic solvent and then inverted into water (e.g., via at least partial neutralization with a suitable base such as, e.g., an amine or any of the other bases disclosed herein) and used to support emulsion polymerization of the ethylenically unsaturated monomer component. In some embodiments, the acid- or anhydride-functional organic solution polymerized acrylic polymer is formed from an ethylenically unsaturated monomer component that includes an acid- or anhydride functional monomer, a branched and/or cyclic monomer, and optionally any other suitable ethylenically unsaturated monomer. In some such embodiments, the acrylic polymer is styrene-free.

Examples of suitable polymerizable surfactants include those disclosed in U.S. Publication No. 2002/0155235 (Taylor et al.); those disclosed in U.S. Pat. No. 10,800,941 (Gibanel et al.), and those commercially available under the tradename REASOAP from Adeka Corporation, Tokyo, Japan; under the tradenames NOIGEN and HITENOL from Da-Ichi Kogyo Siyyaku Co., Ltd., Tokyo, Japan; and under the tradenarne SIPOMER from Solvay Rhodia, Brussels, Belgium.

In some embodiments, a non-ionic surfactant is included in the reaction mixture used to make the latex polymer. Any suitable non-ionic surfactant may be employed. Examples of suitable non-ionic surfactants include ethoxylated compounds. In some embodiments, the non-ionic compound is a sucrose ester, sorbitan ester, alkyl glycoside, glycerol ester, or mixture thereof. In some embodiments, a non-ionic surfactant is used that includes hydroxyl groups. Non-ionic surfactants that comprise, or are derived from, polysorbate compounds may be used in some embodiments.

In some embodiments, a surfactant or mixture of surfactants as described in U.S. Publication No. 2020/0385601 (Gibanel et al.). For example, one or more anionic or zwitterionic surfactant (e.g., non-polymeric surfactant) having an acid group neutralized with a metallic base may be used (e.g., a metallic base including aluminum, calcium, lithium, magnesium, sodium, or potassium). An example of such a surfactant is dioctyl sodium sulfosuccinate.

In preferred embodiments, the latex polymer is prepared using a single-stage or multi-stage emulsion polymerization process (not counting any emulsion polymerization step that may be employed to make a “seed” optionally used to facilitate the overall emulsion polymerization). The emulsion polymerization process may be conducted in a variety of manners. For example, the emulsion polymerization reaction of the ethylenically unsaturated monomer component can occur as a batch, intermittent, or continuous operation.

In some embodiments, the emulsion polymerization process uses an optional pre-emulsion monomer mixture in which some or all of the reactant components and one or more surfactants are dispersed in the aqueous carrier under agitation to form a stable pre-emulsion. In other embodiments, the ethylenically unsaturated monomer component is polymerized without the use of a pre-emulsion step.

A portion of the surfactant(s) and a portion of the aqueous carrier may also be introduced into a reactor, and are preferably heated, agitated, and held under nitrogen sparge to assist in the subsequent polymerization reactions. Preferred temperatures for heating the surfactant dispersion include temperatures greater than 65° C., and more preferably from 70° C. to 90° C.

The monomer pre-emulsion or non-pre-emulsified ethylenically unsaturated monomer component may be fed to the heated aqueous dispersion in the reactor incrementally or continuously over time. Alternatively, in certain embodiments a batch or semi-batch process may be used to polymerize the reactant monomers in the aqueous dispersion, as described in, for example, U.S. Pat. No. 8,092,876 (O'Brien). In further embodiments, the polymerization process can occur in a classic two-stage (or multiple stage) “core-shell” arrangement. Alternatively, the polymerization process can occur in a multiple stage “inverse core-shell” arrangement as discussed in International Publication No. WO 2015/002958 (Gibanel et al.).

With regard to the conditions of the emulsion polymerization, the ethylenically unsaturated monomer component is preferably polymerized in aqueous medium with a water-soluble free radical initiator.

The temperature of polymerization is typically from 0° C. to 100° C., preferably from 50° C. to 90° C., more preferably from 70° C. to 90° C., and even more preferably from 80° C. to 85° C. The pH of the aqueous medium is usually maintained at a pH of 5 to 12.

Typically, the free radical initiator can he selected from one or more water-soluble peroxides which are known to act as free radical initiators. Examples include hydrogen peroxide and t-butyl hydroperoxide. Redox initiator systems well known in the art (e.g., t-butyl hydroperoxide, erythorbic acid, and ferrous complexes) can also be employed.

Further examples of polymerization initiators which can be employed include polymerization initiators which thermally decompose at the polymerization temperature to generate free radicals. Examples include both water-soluble and water-insoluble species. Further examples of free radical initiators that can be used include persulfates, such as ammonium or alkali metal (potassium, sodium or lithium) persulfate; azo compounds such as 2,2′-azo-bis(isobutyronitrile), 2,2′-azo-bis(2,4-dimethylvaleronitrile), and 1-t-butyl-azocyanocyclohexane; hydroperoxides such as t-butyl hydroperoxide, hydrogen peroxide, t-amyl hydroperoxide, methyl hydroperoxide, and cumene hydroperoxide; peroxides such as benzoyl peroxide, caprylyl peroxide, di-t-butyl peroxide, ethyl 3,3′-di(t-butylperoxy) butyrate, ethyl 3,3′-di(t-amylperoxy) butyrate, t-amylperoxy-2-ethyl hexanoate, and t-butylperoxy pivilate; peresters such as t-butyl peracetate, t-butyl perphthalate, and t-butyl perbenzoate; as well as percarbonates, such as di(1-cyano-1-methylethyl)peroxy dicarbonate; perphosphates, and the like; and combinations thereof.

Polymerization initiators can be used alone or as the oxidizing component of a redox system, which also preferably includes a reducing component such as ascorbic acid, malic acid glycolic acid, oxalic acid, lactic acid, thiogycolic acid, or an alkali metal sulfite, more specifically a hydrosulfite, hyposulfite or metabisulfite, such as sodium hydrosulfite, potassium hyposulfite and potassium metabisulfite, or sodium formaldehyde sulfoxylate, benzoin and combinations thereof. The reducing component is frequently referred to as an accelerator or a catalyst activator.

The initiator and accelerator (if any) are preferably used in proportion from 0.001% to 5% each, based on the weight of monomers to be copolymerized. Promoters such as chloride and sulfate salts of cobalt, iron, nickel, or copper can be used in small amounts, if desired. Examples of redox catalyst systems include tert-butyl hydroperoxide/sodium formaldehyde sulfoxylate/Fe(II), and ammonium persulfate/sodium bisulfite/sodium hydrosulfite/Fe(II).

Chain transfer agents can be used to control polymer molecular weight, if desired.

After the polymerization is completed, at least a portion of the carboxylic acid groups and/or anhydride groups of the latex polymer (or other salt-forming groups such as, e.g., other neutralizable acid groups and/or neutralizable base groups) may be neutralized or partially neutralized with a suitable basic compound (or other suitable neutralizing compound) to produce water-dispersing groups. The basic compound used for neutralization can be a metallic base, a fugitive base (e.g., ammonia and primary, secondary, and/or tertiary amines), or a mixture thereof. In preferred embodiments, the base is a fugitive base, more preferably an amine. The degree of neutralization may vary considerably depending upon the amount of acid or base groups included in the latex polymer, and the degree of dispersibility that is desired.

Although any suitable base may be used to neutralize or partially neutralize acid groups of the latex to form anionic salt groups, amines are preferred bases, with tertiary amines being particularly preferred. Some examples of suitable tertiary amines are trimethyl amine, dimethylethanol amine (also known as dimethylamino ethanol), methyldiethanol amine, triethanol amine, ethyl methyl ethanol amine, dimethyl ethyl amine, dimethyl propyl amine, dimethyl 3-hydroxy-1-propyl amine, dimethylbenzyl amine, dimethyl 2-hydroxy-1-propyl amine, diethyl methyl amine, dimethyl 1-hydroxy-2-propyl amine, triethyl amine, tributyl amine, N-methyl morpholine, and mixtures thereof. Most preferably triethyl amine or dimethyl ethanol amine is used as the tertiary amine. Some additional examples of neutralizing bases for forming anionic salt groups include inorganic and organic bases such as sodium hydroxide, potassium hydroxide, lithium hydroxide, ammonium hydroxide, and mixtures thereof. In preferred embodiments, the base is a fugitive base, more preferably an amine. The degree of neutralization may vary considerably depending upon the amount of acid or base groups included in the latex polymer, and the degree of dispersibility that is desired.

The emulsion polymerized polymer of the acrylic latex may have any suitable molecular weight. The latex polymer may be of any suitable molecular weight. In some embodiments, the latex polymer has a number average molecular weight (Mₙ) of greater than 20,000, greater than 30,000, greater than 100,000, greater than 200,000, or greater than 300,000. The upper range of the Mₙ is not restricted and may be 1,000,000 or more. In certain embodiments, however, the Mₙ is less than 1,000,000, less than 600,000, or less than 400,000. Gel permeation chromatography (GPC) using polystyrene standards is a useful method for determining Mn. Because in some embodiments the molecular weight may be too high to measure (e.g., via. GPC analysis using polystyrene standards), it may be necessary to determine the number average molecular weight via theoretical calculation.

The acrylic latex may have any suitable glass transition temperature (Tg). In preferred embodiments, the acrylic latex has a Tg of at least 0° C., at least 5° C., at least 10° C., at least 15° C., at least 20° C., or at least 25° C. In embodiments intended for use in forming easy open end coatings, and particularly interior such coatings (e.g., interior coatings on riveted interior steel or aluminum beverage can ends), the acrylic latex preferably exhibits a Tg of no higher than 50° C., no higher than 45° C., or no higher than 40° C. In some embodiments, the acrylic latex exhibits a Tg of no higher than 35° C., no higher than 30° C., or no higher than 25° C. Differential scanning calorimetry (DSC) is an example of a useful method for determining the Tg of the latex, with a representative DSC methodology provided in the test method section described below.

Coating compositions of the present disclosure preferably include at least a film-forming amount of the acrylic latex described herein. In preferred embodiments, the coating composition includes at least 50 at least 65 at least 80 or at least 90 wt-% of the acrylic latex, based on the total solids weight of the coating composition. The coating composition preferably includes less than 99 wt-%, or less than 95 wt-% of the acrylic latex described herein, based on the total solids weight of the coating composition.

### Crosslinker

In preferred embodiments, the aqueous coil coating compositions are formulated using one or more curing agents or crosslinking resins, sometimes referred to simply as crosslinkers. The choice of particular crosslinker typically depends on the particular product being formulated. The use of carboxyl-reactive crosslinkers, and particularly certain nitrogen-containing carboxyl-reactive crosslinkers, are preferred for the coating compositions.

The carboxyl-reactive crosslinker can include any suitable number of nitrogen atoms, although it will typically include one or more, or two or more, nitrogen atoms. Such crosslinkers are not derived from formaldehyde.

The carboxyl-reactive crosslinker can have any suitable combination of one or more carboxyl-reactive functional groups, and more preferably includes two or more such groups. Hydroxyl groups are preferred carboxyl-reactive groups. Other suitable carboxyl-reactive groups may include, for example, carbodiimide, oxazoline, and aziridine groups. In some embodiments, the carboxyl-reactive crosslinker includes two or more, three or more, or four or more hydroxyl groups.

In some embodiments, the crosslinker (e.g., a hydroxy alkylamide) has a hydroxyl number of at least 100, at least 200, at least 300, at least 400, or at least 500 mg KOH/g resin.

In certain embodiments of the coating composition, the acrylic latex and crosslinker are present in a ratio of molar equivalents of carboxyl groups in the acrylic latex to hydroxyl groups in the crosslinker of at least 1.5:1, preferably at least 2:1 (e.g., COOH groups to OH groups). In certain embodiments of the coating composition, the acrylic latex and crosslinker are present in a ratio of molar equivalents of carboxyl groups in the acrylic latex to hydroxyl groups in the crosslinker of up to 6:1, or up to 5:1 (e.g., COOH groups to OH groups). If the ratio is lower than 1.5:1 (latex carboxyl groups to crosslinker hydroxyl groups), the flexibility of the coil coating composition is too low in certain embodiments for effective stamping of a can end. If the ratio is higher than 6:1 (latex carboxyl groups to crosslinker hydroxyl groups), other properties (such as solvent resistance, chemical resistance, and adhesion) of the coil coating composition may be adversely affected.

Herein, “carboxyl equivalents” and “carboxyl groups” includes carboxylic acid groups as well as neutralized acid groups (i.e., carboxylate groups) and anhydride groups (an anhydride group counts as two carboxyl equivalents). The ratio of molar equivalents of carboxyl groups in the acrylic latex to hydroxyl groups in the crosslinker is calculated as shown.

The number of equivalents of COOH groups in the acrylic latex is based on the measured acid value of the latex (i.e., resin). Acid value (also called acid number or acidity) is the mass of potassium hydroxide (KOH) in milligrams that is required to neutralize one gram of chemical substance. The acid value is used to calculate the number of COOH groups per unit of mass of resin:

$${AV}_{( resin )} = \frac{AE \times M ( KOH ) \times 1000}{{m}_{( dry resin )}} ⇔ AE = \frac{{AV}_{( resin )} \times {m}_{( dry resin )}}{M ( KOH ) \times 1000}$$

wherein:
AV (resin): Acid value of the latex, measured (in mg/g)
AE: Acid Equivalent=eAc=eCOOH=equivalent of COOH group in the latex (in moles)
M(KOH): Molecular weight of Potassium Hydroxyde (KOH)=56.1 g/mol
m(dry resin): dry mass of the latex (in g) (=% wt of latex in the formula x % dry content in the latex).

The number of equivalents of hydroxyl groups in the crosslinker (e.g., PRIMID crosslinker) is based on the same principle as calculation of COOH group in the latex. Hydroxyl value is the mass of potassium hydroxide (KOH) that is required to neutralize the acetic acid taken up on acetylation of one gram of the chemical substance that contains free hydroxyl groups. Hydroxyl value measured on the PRIMID crosslinker using, e.g., ISO4629 Test Method, allows the calculation of the number of OH groups per unit of mass of crosslinker PRIMID crosslinker) (i.e., resin):

$${HV}_{( resin )} = \frac{HE \times M ( KOH ) \times 1000}{{m}_{( dry resin )}} ⇔ HE = \frac{{HV}_{( resin )} \times {m}_{( dry resin )}}{M ( KOH ) \times 1000}$$

wherein:
HV (resin): Hydroxyl value of the crosslinker, measured (in mg/g)
HE: Hydroxyl Equivalent=eOH=equivalent of OH group in the crosslinker (in moles)
M(KOH): Molecular weight of Potassium Hydroxyde (KOH)=56.1 g/mol
m(dry resin): dry mass of the crosslinker (in g) (=% wt of dry crosslinker in the formula).

The coating compositions herein preferably include at least 0.5 wt-%, at least 1 wt-%, at least 1.5 wt-%, at least 2 wt-%, at least 2.5 wt-%, or at least 3 wt-% of the crosslinker, based on total solids weight of the coating composition. While the upper amount of the crosslinker may vary depending upon the particular embodiment, typically the coating composition will include less than 30 wt-%, less than 20 wt-%, less than 15 wt-%, less than 10 wt-%, or less than 7 wt-% of the crosslinker, based on total solids weight of the coating composition.

The coating compositions of the present disclosure can include a mixture of crosslinkers, wherein the mixture of crosslinkers includes more than 50 wt-%, more than 66 wt-%, or more than 80 wt-% of the nitrogen-containing carboxyl-reactive crosslinker described herein, based on the total weight of the crosslinker.

In some embodiments, the carboxyl-reactive crosslinker includes two or more nitrogen atoms, and, in some embodiments, two total nitrogen atoms. In other embodiments, one or more and more preferably two or more) nitrogen atoms are present in an amide group, an aziridine group, an imide group, a diimide group, an oxazoline group, a urethane group, or a combination thereof. In certain embodiments, the crosslinker includes at least one amide group, at least one imide group, or combinations thereof.

In some embodiments, the nitrogen-containing carboxyl-reactive crosslinker includes two or more amide groups. In yet other embodiments, the nitrogen-containing carboxyl-reactive crosslinker may contain a single amide group such as, for example, a poly-substituted amide group having two or more hydroxyl groups. In a preferred embodiment, the nitrogen-containing carboxyl-reactive crosslinker includes a beta-hydroxyl group relative to a nitrogen atom of an amide bond.

Suitable nitrogen-containing carboxyl-reactive crosslinkers include hydroxyalkylamide crosslinkers. These allow for production of a preferred formaldehyde-free aqueous coating composition including the acrylic latex described above and having sufficient flexibility for use as an interior or exterior coating of an easy open beverage can end, By way of example, the preferred hydroxyalkylamide crosslinker PRIMID QM1260 from EMS-GRILTECH has a hydroxyl number of 550 to 650 mgKOH/g according to the manufacturer.

In certain preferred embodiments, the nitrogen containing carboxyl-reactive crosslinker includes one or more, and more preferably two or more, groups having the structure of the below Formula (III):

HO—R⁵—N(R⁶)—C(═O)— (III)

wherein each R⁵ is independently an organic group, and each R⁶ is independently hydrogen or an organic group. As shown in Formula (III), the depicted hydroxyl group can be a primary hydroxyl group, secondary hydroxyl group, or tertiary hydroxyl group depending on the structure of R⁵. In some embodiments, the hydroxyl group is a primary hydroxyl group.

In Formula (III), R⁵ can include any suitable number of carbon atoms, but will typically include from 2 to 10 carbons atoms, more typically from 2 to 8 carbon atoms, more typically from 2 to 6 carbons atoms, and even more typically from 2 to 4 carbon atoms. In Formula (III), R⁵ will typically include at least two carbon atoms in a chain connected on one end to the depicted nitrogen atom and on the other end to the depicted hydroxyl group. In an embodiment, the depicted hydroxyl group is attached directly to a first carbon atom, which is attached directly to a second carbon, which is in-turn attached directly to the depicted nitrogen atom. In some embodiments of Formula (III), R⁵, is a —(CH₂)₂— moiety. In yet other embodiments of Formula (III), R⁵ is an alkylene group preferably containing from 1 to 5 carbon atoms (e.g., methylene, ethylene, n-propylene, sec-propylene, n-butyl, sec-butylene, tort-butylene, pentylene, etc.).

In some embodiments of Formula (III), R⁶ is an organic group that includes a hydroxyl group. In some such embodiments of Formula (III), R⁶ has the structure HO—R⁵—, wherein R⁵ is as described above. Examples of such R⁶ groups include hydroxyl alkyl groups preferably having from 1 to 5 carbon atoms (e.g., methylol, hydroxy-methyl, hydroxy-ethyl, 3-hydroxy-propyl, 2-hydroxy-propyl, 4-hydroxy-butyl, 3-hydroxy-butyl, 2-hydroxy-2-propyl-methyl, 5-hydroxy-pentyl, 4-hydroxy-pentyl, 3-hydroxy-pentyl, 2-hydroxy-pentyl and the pentyl isomers). One example of a nitrogen containing carboxyl-reactive crosslinker including such R⁶ groups is provided below in Formula (IV) (which is believed to be the structure of the PRIMID XL-552 product commercially available from EMS):

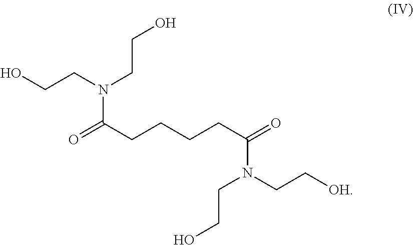 [SMILES: O=C(CCCCC(=O)N(CCO)CCO)N(CCO)CCO]

In certain preferred embodiments, the nitrogen containing carboxyl-reactive crosslinker is a compound having the structure of the below Formula (V):

(HO—R⁵—N(R⁶)—C(═O))ₙ—X (V)

wherein R⁵ and R⁶ are as described above for Formula (III), n is an integer of 2 or more, and X is a polyvalent organic group.

In yet other embodiments, the nitrogen containing carboxyl-reactive crosslinker is a compound having the structure of Formula (VI):

HO—R⁵—N(R⁶)—C(═O)—X—C(═O)—N(R⁶)—(R⁵)—OH (VI)

wherein R⁵ and R⁶ of Formula (VI) are independently organic groups, X is a bivalent organic group, and wherein the hydroxyl groups are independently primary or secondary hydroxyl groups. In some embodiments of Formula (VI), X is an alkylene group. In other embodiments of Formula (VI), X is a —(CH₂)ₘ— group wherein (i) m is an integer of 1 or more, 2 or more, 3 or more, 4 or more, and more typically from 2 to 10 and (ii) one or more hydrogens may be replaced with substituent groups (e.g., organic substituent groups). In an embodiment, X is —(CH₂)₄—.

In certain embodiments, the hydroxyl group attached to the R⁵ moiety or of the R⁶ moiety of Formula (V) or (VI) is a secondary hydroxyl group or located in a beta position relative to a nitrogen atom, more preferably a nitrogen atom of an amide bond. Thus, for example, in certain embodiments, the nitrogen-containing carboxyl-reactive crosslinker is a beta-hydroxyalkylamide compound. Some examples of such compounds include: bis[N,N-di(β-hydroxy-ethyl)]adipamide, bis[N,N-di(β-hydroxy-propyl)]succinamide, bis[N,N-di(β-hydroxy-ethyl)]azelamide, bis[N,N-di(β-hydroxy-propyl)]adipamide, bis[N-metil-N-(β-hydroxy-ethyl)]oxamide, and mixtures thereof. The PRIMID QM-1260 product commercially available from EMS is an example of a preferred beta-hydroxyalkylamide crosslinker. The structure believed to correspond to the PRIMID QM-1260 product is provided by Formula (VII) below:

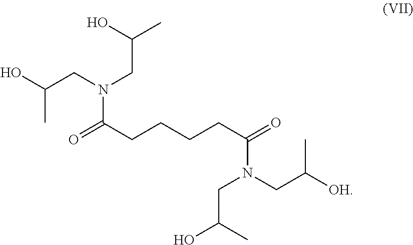 [SMILES: CC(O)CN(CC(C)O)C(=O)CCCCC(=O)N(CC(C)O)CC(C)O]

Without intending to be bound by theory, the use of hydroxyl alkylamides, and particularly beta-hydroxyalkylamides, such as those of Formula (V), (VI), or (VII), is preferred in some embodiments due to the formation of an oxazolinium intermediate that is believed to occur and result in enhanced reactivity of the crosslinker with carboxyl groups (e.g., on the acrylic copolymer). Thus, in sonic embodiments, the nitrogen containing carboxyl-reactive crosslinker is preferably capable of forming an oxazolinium intermediate or other carbon-nitrogen heterocyclic intermediate having enhanced reactivity with carboxyl groups. Preferably, such reactive intermediates are formed under the short cure time of typical beverage can ends coating thermal cure conditions. For example, for coating cure conditions, such reactive intermediates may be formed in some embodiments even at oven bake conditions haying a peak metal temperature from 200° C. to 260° C. (in some embodiments, 230° C. to 260° C.) and during a relative short oven residence time of only 8 seconds to 20 seconds, 8 seconds to 15 seconds, 8 seconds to 12 seconds, or even 10 seconds to 12 seconds.

In preferred embodiments, the nitrogen-containing carboxyl-reactive crosslinker is formed from reactants that do not include formaldehyde. Preferred carboxyl-reactive crosslinkers are also substantially free of, completely free of, and preferably do not include any structural units derived from, BPA and aromatic glycidyl ether compounds (e.g., BADGE, BFDGE, and epoxy novalacs)

In yet other embodiments, the crosslinker may include a carbodiimide polymer or a carbodiimide structural moiety. Exemplary such carbodiimide crosslinkers or moieties thereof may include, but are not limited to, aliphatic and/or cycloaliphatic dinitrogen derivatives of carbonic acid. Such crosslinkers have the general structure: R′N═C═NR′ where R′ is independently aliphatic or cycloaliphatic groups. The aliphatic group of R′ may a carbon chain of 1 to 6 carbon atoms. Suitable examples of carbodiimide moieties or crosslinkers include dibutyl carbodiimide and dicyclohexyl carbodiimide. Polymeric or oligomeric carbodiimide crosslinkers can also he used. Water dispersible carbodiimide crosslinkers may be prepared by incorporating minor amounts of an amine, such as dimethyl aminopropylamine, and an alkyl sulfonate or sulfate into the carbodiimide structure. Suitable water dispersible carbodiimides can also be prepared by incorporating polyethylene oxide or polypropylene oxide into the carbodiimide structure. Exemplary carbodiimide crosslinkers are disclosed in International Publication No. WO 2019/118697 (PPG Industries, Ohio, Inc.

In other embodiments, the carboxyl-reactive crosslinker comprises an oxazoline crosslinker, particularly a polyoxazoline crosslinker. As used heroin, the term “polyoxazoline” means a compound containing at least two (2) oxazoline groups. Said compound may be monomeric or polymeric. Suitable monomeric polyoxazolines include a bis-oxazoline and/or a tris-oxazoline. Exemplary oxazoline crosslinkers are disclosed in International Publication Nos. WO 2014/139972 (Akzo Nobel Coatins International B.V.) and WO 2019/116328 (PPG Industries, Ohio, Inc.).

In some embodiments, the coating compositions, as disclosed herein, may optionally include one or more catalysts at a suitable level to produce the desired result (e.g., to increase the rate of cure and/or the extent of crosslinking). Non-limiting examples of catalysts, include, but are not limited to, strong acids (e.g., dodecylbenzene sulphonic acid (DDBSA, available as CYCAT 600 from Cytec), methane sulfonic acid (MSA), p-toluene sulfonic acid (pTSA), dinonylnaphthalene disulfonic acid (DNNDSA), and triflic acid), quaternary ammonium compounds, phosphorous compounds, titanium compounds (e.g., titanium acetylacetonate, tetraalkyltitanates, isopropylorthotitanate, water-soluble titanium chelated salts, triethanolamine chelates of titanium, tetratriethanolamine chelates of titanium, lactic acid titanate chelate salts), zinc compounds, and combinations thereof. Specific examples include, but are not limited to, a tetraalkyl ammonium halide, a tetraalkyl or tetraaryl phosphonium iodide or acetate, zinc octoate, triphenylphosphine, and similar catalysts known to persons skilled in the art. If used, a catalyst is preferably present in an amount of at least 0.01 wt-%, or at least 0.1 wt-%, based on the weight of nonvolatile material in the coating composition. If used, a catalyst is preferably present in an amount of no greater than 3 wt-%, or no greater than 1 wt %, based on the weight of nonvolatile material in the coating composition. In preferred embodiments, any such cure catalysts used do not include tin.

### Optional Ingredients

The beverage can end coil coating compositions (whether aqueous or powder coating composition) of the present disclosure include at least 80 wt-%, by weight of total resin solids, of an acid- or anhydride-functional acrylic latex comprising an emulsion polymerized polymer. The beverage can end coil coating compositions of the present disclosure may also include other optional (secondary) polymers that do not adversely affect the coating composition or a cured coating composition resulting therefrom. Such secondary polymers are typically included in a coating composition as a filler material, although they can be included as a crosslinking material, or to provide desirable properties. One or more optional polymers (secondary polymers) can be included in a sufficient amount to serve an intended purpose, but not in such an amount to adversely affect a coating composition or a cured coating composition resulting therefrom. Examples of such other optional polymers may include polyolefins, polyesters, polyurethanes, polyethers (i.e., epoxy polymers), and copolymers thereof.

While the coating composition may optionally include one or more polyester polymers, in preferred embodiments, the coating composition includes, based on total resin solids, no more than 20 wt-%, no more than 10 wt-%, no more than 5 wt-%, or no more than 1 wt-%, if any, polyester polymers.

Similarly, while the coating composition may optionally include one or more polyolefin polymers, in preferred embodiments, the coating composition includes, based on total resin solids, no more than 20 wt-%, no more than 10 wt-%, no more than 5 wt.-%, or no more than 1 wt-%, if any, polyolefin polymers.

Similarly, while the coating composition may optionally include one or more polyurethane polymers, in preferred embodiments, the coating composition includes, based on total resin solids, no more than 20 wt %, no more than 10 wt-%, no more than 5 wt-%, or no more than 1 wt-%, if any, polyurethane polymers.

While the coating composition may optionally include one or more polyether polymers, in preferred embodiments, the coating composition includes, based on total resin solids, no more than 20 wt-%, no more than 10 wt-%, no more than 5 wt-%, or no more than 1 wt-%, if any, polyether polymers.

In preferred embodiments, coating compositions of the present disclosure are “epoxy-free” and are not made using any polymers or other material having epoxy backbone segments.

When used, optional ingredients are typically included in the coating composition to enhance composition aesthetics, to facilitate manufacturing, processing, handling, and application of the composition, and/or to further improve a particular functional property of a coating composition or a cured coating composition resulting therefrom. Suitable optional ingredients max include, for example, pigments, extenders, fillers, lubricants, anticorrosion agents, flow control agents, thixotropic agents, dispersing agents, antioxidants, adhesion promoters, light stabilizers, surfactants, and mixtures thereof. Each optional ingredient is preferably included in a sufficient amount to serve its intended purpose, but not in such an amount to adversely affect a coating composition or a cured coating composition resulting therefrom.

A particularly useful optional ingredient may be a lubricant (e.g., a wax), which facilitates manufacture of easy open ends by imparting lubricity and flexibility to sheets or coils of coated metal substrate. Examples of lubricants include, for example, carnauba wax, Fischer-Tropsch wax, fatty acid ester wax, silicon-based wax, lanolin wax, hydroxy functional polysiloxane wax (such as, e.g., described in U.S. Pat. No. 9,169,406 (Wilbur et al.)), polytetrafluoroethylene (PTFE) wax, polyolefin wax (e.g., polyethylene (PE) wax, polypropylene (PP) wax, and high-density polyethylene (HDPE) wax), amide wax (e.g., micronized ethylene-bis-stearamide (EBS) wax), combinations thereof, and modified version thereof (e.g., amide-modified PE wax, PTFE-modified PE wax, and the like). The lubricants may be micronized waxes, which may optionally be spherical.

Examples of suitable commercially available lubricants include the CERETAN line of products from Munzing (e.g., the CERETAN MA 7020, MF 5010, MM 8015, MT 9120, and MXD 3920 products); the LUBA-PRINT line of products from Munzing (e.g., the LUBA-PRINT 255/B, 276/A (ND), 351/G, 501/S-100, 749/PM, and CA30 products); the SST-52. S-483, FLUOROSLIP 893-A, TEXTURE 5347W, and SPP-10 products from Shamrock; the CERAFLOUR line of products from BYK (e.g., the CERAFLOUR 981, 988, 996, 258, and 970 products); and the CERACOL 607 product from BYK.

In some embodiments, PTFE-free lubricants (i.e., those that do not contain polytetrafluoroethylene) are preferred. In some embodiments, the coating composition is free of any lubricants made using fluorine-containing ingredients. In some embodiments, the coating composition is free of any fluorine-containing ingredients.

If used, one or more lubricants can be present in the coating composition in an amount of at least 0.1 wt-%, at least 0.25 wt-%, at least 0.5 wt-%, or at least 0.75 wt-%, based on the total weight of solids in the coating composition. In other embodiments, the lubricant may be present in the coating composition in in an amount of no greater than 3 wt-%, no greater than 2 wt-%, no greater than 1.5 wt-%, no greater than 1.25 wt-%, or no greater than 1 wt-%, based on the total weight of solids in the coaling composition.

The lubricant may be present in (i.e., incorporated within) the coating composition of the present disclosure. The lubricant may also be applied to the coating composition after the coating composition is applied to a substrate. That is, the lubricant may be present in a second coating composition that is applied in a separate layer on a layer of the coating composition of the present disclosure.

Another useful optional ingredient is a pigment, such as titanium dioxide. If used, one or more pigments can be present in the coating composition in an amount of no greater than 25 wt-%, and typically in an amount of 15 wt-% to 25 wt-%, based on the total weight of the coating composition.

Surfactants can be optionally added to the coating composition to aid in flow and wetting of the substrate. Examples of surfactants, include, but are not limited to, nonylphenol polyethers and salts and similar surfactants known to persons skilled in the art. If used, one or more surfactants can be present in an amount of at least 0.01 wt-%, in certain embodiments at least 0.1 wt-%, based on the total weight of resin solids. If used, one or more surfactants can be present in an amount no greater than 10 wt-%, and in certain embodiments no greater than 5 wt-%, based on the total weight of resin solids. In some embodiments, the coating composition does not include any surfactants.

### Carrier Fluid

The aqueous coating compositions herein may include any suitable amount of water, optionally (and preferably) in combination with one or more organic solvents. In some embodiments, the amount of liquid carrier is selected so that the total non-volatile solids content of the coating composition is preferably in the range of from 10 wt-% to 50 wt-%, more preferably 20 wt-% to 40 wt-%, based on the total weight of the composition. For example, and more preferably, the composition may include 30 wt-% to 40 wt-% total non-volatile solids content based on the total weight of the composition.

The carrier fluid (e.g., aqueous carrier) may constitute the remainder of the weight of the coating composition. In certain embodiments, the coating compositions of the present disclosure have a viscosity at 25° C. measured via ASTM D-1200 of 30 seconds to 80 seconds, or 35 seconds to 60 seconds, using a number Ford #2 cup.

In preferred embodiments, the carrier fluid is water. In certain embodiments, the coating composition includes at least 10 wt-%, at least 20 wt-%, at least 25 wt-%, at least 35 wt-%, or at least 50 wt-% of water, based on the total weight of the coating composition.

In other embodiments, carrier fluid may include one or more organic solvents, preferably one or more water-miscible organic solvents. In some embodiments, the organic solvents may include one or more of isopropyl alcohol, ethanol, methanol, butyl alcohol, amyl alcohol, diads, glycol ethers (i.e., butyl glycol), glycol esters, glycol ether esters, mineral spirits, aromatic solvents, acetone, ketones such as methyl ethyl ketone, or tetrahydrofuran or mixtures thereof.

In some embodiments, the coating composition is an aqueous coating composition that includes at least 5 wt-% of one or more organic solvents. In preferred embodiments, the coating composition includes at least some organic solvent, more preferably, at least 5 wt-%, at least 10 wt-%, or at least 15 wt-% of one or more organic solvent, based on total coating weight. Typically, at least some, if not all, of the one or more organic solvents are water-miscible.

### Coil Coating Compositions and Properties Thereof

The coil coating compositions of the present disclosure are typically aqueous-based, i.e., contain water as part or all of the carrier fluid. If desired, however, the coil coating compositions may be spray dried and in the form of powdered particles. Examples of such powder coating compositions and methods of use in packaging are described in International Publication Nos. WO 2021/097308 and WO 2022/246120, both to SWIMC LLC.

In some embodiments, the coil coating composition, when cured in a beverage can end coil bake, has a glass transition temperature (Tg) of from 10° C. to 50° C., preferably from 15° C. to 45° C., and more preferably, from 20° C. to 40° C. Differential scanning calorimetry (DSC) is an example of a useful method for determining the Tg of the coil coating composition, with a representative DSC methodology. While not intending to be bound by theory, it is believed that if the Tg of the cured coating is too low one or more properties such as, e.g., flavor scalping or corrosion resistance may be unsuitable. Similarly, if the Tg is too high, one or more properties such as flexibility (e.g., as indicated by porosity values prior to and/or after pasteurization or retort) may be unsuitable.

While the coating compositions of the present disclosure do not require the use of any crosslinkers derived from formaldehyde to exhibit good beverage can end performance, some amount of such crosslinker(s) may he employed if desired. In some embodiments, the coil coating compositions include less than 2 wt-% or less than 1 wt-%, by weight of total solids, of a crosslinker derived from formaldehyde, if any. In some embodiments, the coil coating compositions are substantially free of, completely free of, or do not contain a crosslinker derived from formaldehyde. In some embodiments, the coil coating compositions herein are formaldehyde-free.

In preferred embodiments, no formaldehyde-containing or formaldehyde-derived compounds are used to prepare the coating composition, although trace amounts may be present due to, for example, environmental contamination. Because phenoplast crosslinker resins are typically prepared from reactants including formaldehyde, in preferred embodiments the coating composition does not include any phenoplast crosslinker. Similarly, in preferred embodiments, the coating composition also does not include any benzoguanamine-formaldehyde, melamine-formaldehyde, or urea-formaldehyde crosslinkers. In presently preferred embodiments, the coating composition also does not include any isocyanate crosslinkers.

In some embodiments, the coil coating compositions are free of bisphenol A, bisphenol F, and bisphenol S. In some embodiments, the coil coating compositions do not include any intentionally added bisphenol components (such as bisphenol A, bisphenol S, or bisphenol F).

In certain embodiments, the aqueous coating compositions herein are substantially free of all bisphenol compounds. In certain embodiments, the aqueous coating compositions are completely free of all bisphenol compounds. By way of example, hydroquinone, resorcinol, catechol, and the like are not bisphenols because these phenol compounds only include one phenylene ring.

The amount of bisphenol compounds (e.g., bisphenol A, bisphenol F, and bisphenol S), as well as structural units derived therefrom can be determined based on starting ingredients; a test method is not necessary and parts per million (ppm) can be used in place of weight percentages for convenience in view of the small amounts of these compounds. In certain preferred embodiments, no bisphenol compounds are used (i.e., they are not intentionally added), although trace amounts may be present due to, for example, environmental contamination.

In some such embodiments, the coil coating compositions are epoxy-free. That is, “epoxy-free” coating compositions are not made using any polymers or other material having epoxy backbone segments.

In some embodiments, the acrylic latex, and preferably the overall coil coating composition is substantially free of, completely free of, or does not contain glycidyl acrylate and glycidyl methacrylate monomers (whether free or polymerized).

In some embodiments, the acrylic latex, and preferably the overall coil coating composition, is substantially free of, completely free of, or does not contain (meth)acrylamide-type monomers (e.g., acrylamides or methacrylamides, N-isobutoxymethyl acrylamide, N-butoxymethyl acrylamide) or structural units derived therefrom.

In some embodiments, the acrylic latex, and more preferably the overall coil coating composition, is substantially free of, completely free of, or does not contain vinyl aromatic monomers (whether free or polymerized). In some embodiments, the coil coating compositions are styrene-free.

In some embodiments, the acrylic latex, and more preferably the overall coil coating composition, is substantially free of, completely free of, or does not contain halogenated monomers (whether free or polymerized).

In some embodiments, the coating composition is free of any fluorine-containing ingredients.

In preferred embodiments, the aqueous coating compositions herein, when applied to a cleaned and chrome-free pretreated aluminum panel and cured for 12 seconds oven cure time to a peak metal temperature of 249° C. to achieve a dried film thickness of approximately 11 grams per square meter (i.e., 10-12 gsm) and formed into a fully converted (typically, 206) standard opening beverage can end, passes less than 5 milliamps of current, preferably less than 2 milliamps of current, and even more preferably less than 1 milliamp of current, while being exposed for 4 seconds to an electrolyte solution containing 1% by weight of NaCl dissolved in deionized water.

Exemplary coatings of the present invention display one or more of the properties described in the Examples Section. In some embodiments, the coatings of the present disclosure, when applied to a cleaned and chrome-free, zirconium-pretreated aluminum panel and cured for 12 seconds to a peak metal temperature of 249° C. to achieve a dried film thickness of approximately 11 (i.e., 10-12) grams per square meter, and preferably formed into a fully converted (typically, 206) standard opening beverage can end, display one or more of the following properties and in some embodiments all properties or various combinations of such properties):
MEK solvent resistance of at least 30 double rubs;
a blush rating after water pasteurization of at least 6;
an adhesion rating of GT0 or GT1; and
feathering, if any, of 0.5 mm or less, 0.4 mm or less, 0.3 mm or less, 0.2 mm or less, or 0.1 mm or less, or none.

Herein, MEK solvent resistance, blush, and adhesion were tested on flat panels. The values of such parameters will not change if then formed into a fully converted (e.g., 206) standard opening beverage can end and then tested.

### Beverage Cans and Methods

As described above, the coating compositions herein are particularly well adapted for use on beverage cans, particularly can ends, subjected to short cure cycles. Two-piece cans are manufactured by joining a can body (typically a drawn metal body) with a can end (typically an easy open can end formed from aluminum or steel or sheet). The coatings of the present invention are suitable for use in coating coil substrates for use in making beverage can ends.

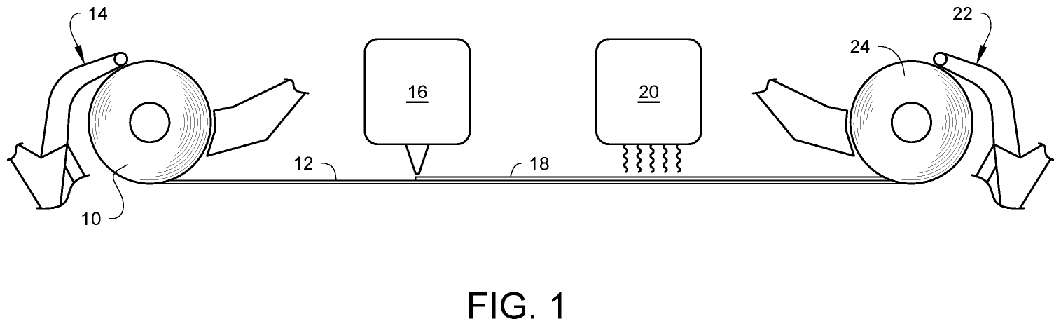

A coating process is the coating of a continuous composed of a metal such as steel or aluminum. The metal substrate is in the form of a coil substrate that permits a continuous coating process. FIG. 1 depicts a coil substrate W suitable for receiving an embodiment of the liquid (or powder) polymeric coating composition. The coil substrate has a selected width and thickness and possesses enough length to permit the substrate to be wound into a coil. The coil substrate permits a continuous coating process. For example, a surface 12 of the coil substrate 10 is generally exposed to receive a coating. The placement of a coating on the surface 12 of the coil substrate 10 may occur in a continuous manner involving an unwind station 14, a coating station 16 to apply a coating 18, a curing station 20, and a take-up station 22 at the end to rewind the coated coil 24. The modifications to the liquid polymeric coating composition, as presented in this disclosure, reduce or alleviate edge build and edge blister formation on the coated coil.

Once coated, the coating is subjected to a short thermal, ultraviolet, and/or electromagnetic curing cycle, for hardening (e.g., drying and curing) of the coating. Coatings provide coated metal (e.g., steel and/or aluminum) substrates that can be fabricated into beverage can ends, particularly easy open can ends, an example of which is shown in FIG. 2.

The metal substrates for typical coating process often have an average thickness of 175 to 250 micrometers. Often, a surface of the metal substrate is pretreated with a chromium-based or non-chromium-based (e.g., zirconium and acrylic-based pretreatment) pretreatment prior to coating with the coating composition.

In one example of a coating process, the coating may occur by first providing a substrate, such as aluminum or steel, for forming a beverage can end. Next, the aqueous coating compositions as described herein may be applied to a surface of the substrate (e.g., by roll application or any other suitable technique). Then, the applied aqueous coating composition is cured for a time and at a peak metal temperature to form a cured coating on the surface of the substrate. Finally, the coated aluminum or steel substrate is then formed (e.g., stamped) into an appropriate beverage can or can end.

In some embodiments, the aqueous coating composition may be applied using a conventional roller coating process either continuously on lines or hatch-wise on substrate sheets. In some embodiments, the moving surface of a substrate in a continuous process is traveling at a line speed of at least 50 meters per minute, at least 100 meters per minute, at least 200 meters per minute, or at least 300 meters per minute. Typically, the line speed will be less than 400 meters per minute. For such continuously moving surfaces, the aqueous coating composition is typically applied at coating weights and relative thicknesses to achieve a desired average coating thickness upon curing. In certain embodiments, the resulting average dry film thickness on the substrate may be at least 7 micrometers, at least 8 micrometer, or at least 9 micrometers, and may be up to 11 micrometers, up to 12 micrometers, or up to 15 micrometers (typically for interior coatings) or even thinner for exterior coatings. Once applied onto the substrate, any suitable cure mechanism may be employed. For example, the coating composition can be subjected to thermal convection, ultraviolet radiation, electromagnetic magnetic radiation or combinations thereof in a curing cycle that provides sufficient drying and curing of the coating composition to form a desired final coating.

In some embodiments, the curing time of the coating compositions of this disclosure is at least 6 seconds, at least 10 seconds or at least 12 seconds, and up to 15 seconds, up to 20 seconds, up to 25 seconds or up to 30 seconds. Preferably, the curing time is 8 second to 15 second, 8 seconds to 12 seconds, or 10 to 12 seconds. In the context of thermal bakes to cure the coating, such curing times refer to the residence time in the oven(s). In such embodiments, the curing process is typically conducted to achieve peak metal temperatures (PMT) of 200° C. to 260° C. and, in other embodiments, 230° C. to 255° C.

In any of the above application methods, the coating compositions herein can be applied to a substrate using any suitable procedure including, for example, spray coating, roll coating, coating, curtain coating, immersion coating, meniscus coating, kiss coating, blade coating, knife coating, dip coating, slot coating, slide coating, vacuum coating, and the like, as well as other types of pre-metered coating. Other commercial coating applications and curing methods are also envisioned, including, for example, electro-coating, extrusion coating, laminating, powder coating, (e.g., after spray drying to form powder) and the like.

Depending on the particular application and article, the coating compositions herein can be applied on a substrate prior to, or after, forming the substrate into an article. In some embodiments, at least a portion of a planar metal substrate (e.g., metal coil) is coated with a layer of the coating composition of the present invention, which is then cured before the planar substrate is formed (e.g., stamped) into a can end (e.g., an easy open can end).

After applying the coating composition onto a substrate, the composition can be cured using a variety of processes, including, for example, oven baking conventional methods, or any other method that provides an elevated temperature suitable for curing the coating. The curing process may be performed in either discrete or combined steps. For example, substrates can be dried at ambient temperature to leave the coating compositions in a largely un-crosslinked state. The coated substrates can then be heated to fully cure the compositions. In certain instances, coating compositions of the present invention can be dried and cured in one step.

Embodiments of the liquid polymeric coating composition (or, alternatively, powder coating composition) directed to a beverage can end should preferably exhibit sufficient flexibility in the cured coating composition to accommodate the extreme contour of the rivet portion of the easy open can end. In some embodiments, tests conducted to determine if a particular coating can function as an easy open can end may be the Porosity Test and Feathering Test, set forth herein. The Porosity Test indicates the level of flexibility of a coating and measures the ability of the coating to retain its integrity and substrate adhesion as it undergoes the formation process necessary to produce a beverage can end. In particular, it is a measure of the presence or absence of cracks or fractures in the interior coating of the formed end. Feathering refers to the adhesion loss of a coating adjacent to the drinking spout of a beverage can end and, when present, indicates that a portion of free film may remain across the opening of a can when opened.

The present disclosure also provides methods that include causing the aqueous coating composition to be used on a metal substrate of metal packaging (e.g., metal coil or sheet for use in forming beverage can ends). In some cases where multiple parties are involved, a first party (e.g., the party that manufactures and/or supplies the aqueous coating composition) may provide instructions, recommendations, or other disclosures the packaging coating end use to a second party (e.g., a metal coater (e.g., a coil coater for easy open beverage can ends), can maker, or brand owner). Such disclosures may include, for example, instructions, recommendations, or other disclosures relating to coating a metal substrate for subsequent use in forming packaging cans or portions thereof, coating a metal substrate of pre-formed cans or portions thereof, preparing aqueous coating compositions for such uses, cure conditions or process-related conditions for such coatings, or suitable types of packaged products for use with resulting coatings. Such disclosures may occur, for example, in technical data sheets (TDSs), safety data sheets (SDSs), regulatory disclosures, warranties or warranty limitation statements, marketing literature or presentations, or on company websites. A first party making such disclosures to a second party shall be deemed to have caused the aqueous coating compositions to be used on a metal substrate of metal packaging (e.g., a can or easy open end) even if it is the second party that actually applies the composition to a metal substrate in commerce, uses such coated substrate in commerce on a metal substrate of packaging cans, and/or fills such coated cans with product.

### EMBODIMENTS

Embodiment 1 is a beverage can end coil coating composition comprising: an acid- or anhydride-functional acrylic latex comprising an emulsion polymerized polymer; a carboxyl-reactive crosslinker that is nitrogen-containing and is not derived from formaldehyde; and optionally, a lubricant; wherein the coating composition:
(i) includes less than 2 wt-%, by weight of total solids, of a crosslinker derived from formaldehyde, if any;
(ii) is free of bisphenol A, bisphenol F, and bisphenol S;
(iii) is optionally free of styrene;
(iv) has a glass transition temperature (Tg), as determined by Differential Scanning Calorimetry (DSC), when applied to a cleaned and chrome-free, zirconium-pretreated aluminum panel and cured for 12 seconds to a peak metal temperature of 249° C. to achieve a dried film thickness of approximately 11 (i.e., 10-12) grams per square meter, of 10° C. to 50° C.; and
(v) when applied to a cleaned and chrome-free, zirconium-pretreated aluminum panel and cured for 12 seconds to a peak metal temperature of 249° C. to achieve a dried film thickness of approximately 11 (i.e., 10-12) grains per square meter and formed into a fully converted (typically, 206) standard opening beverage can end, passes less than 5 milliamps of current, while being exposed for 4 seconds to an electrolyte solution containing 1% by weight of NaCl dissolved in deionized water.

Embodiment 2 is the coating composition of Embodiment 1, wherein the acrylic latex has an acid number of at least 40, greater than 40, at least 50, greater than 50, at least 60, greater than 60, at least 70, greater than 70, at least 80, greater than 80, at least 100, greater than 100, at least 150, or greater than 150 mg KOH per gram of the latex. Embodiment 3 is the coating composition of Embodiment 1 or 2, wherein the acrylic latex has an acid number of no greater than 400, less than 400, no greater than 300, less than 300, no greater than 200, less than 200, no greater than 150, less than 150, no greater than 100, or less than 100 mg KOH per gram of the latex. Embodiment 4 is the coating composition of Embodiment 2 or 3, wherein the acrylic latex has an acid number of 40 to 150, 50 to 150, 40 to 100, 50 to 100, 60 to 100, or 100 to 200 mg KOH per gram of the latex.

Embodiment 5 is the coating composition of any preceding Embodiment, wherein the acrylic latex comprises at least 50 wt-%, at least 60 wt-%, at least 70 wt-%, at least 80 wt-%, at least 90 wt %, at least 95 wt %, or at least 98 wt-% of an emulsion polymerized polymer, based on the total solids weight of the acrylic latex.

Embodiment 6 is the coating composition of any preceding Embodiment, wherein the acrylic latex is formed from polymerization of an ethylenically unsaturated monomer component comprising two or more different monomers, and more typically three or more different monomers.

Embodiment 7 is the coating composition of Embodiment 6, wherein the ethylenically unsaturated monomer component comprises a (meth)acrylate monomer, preferably having a Tg of greater than 50° C., greater than 60° C., greater than 70° C., greater than 80° C., greater than 90° C., or greater than 100° C. Embodiment 8 is the coating composition of Embodiment 6 or 7, wherein the ethylenically unsaturated monomer component comprises at least one ethylenically unsaturated acid- or anhydride-functional monomer, including salt thereof, preferably in an amount of at least 5 wt-%, or al least 10 wt-%, based on the total weight of the ethylenically unsaturated monomer component. Embodiment 9 is the coating composition of any of Embodiments 6 to 8, wherein the ethylenically unsaturated monomer component comprises at least one ethylenically unsaturated acid- or anhydride-functional monomer, including salt thereof, preferably in an amount of no more than 20 wt-%, or no more than 15 wt-%, based on the total weight of the ethylenically unsaturated monomer component.

Embodiment 10 is the coating composition of any of Embodiments 6 to 9, wherein the ethylenically unsaturated acid- or anhydride-functional monomers, including salts thereof, comprise acids selected from acrylic acid, methacrylic acid, alpha-chloroacrylic acid, alpha-cyanoacrylic acid, crotonic acid, alpha-phenylacrylic acid, beta-acryloxypropionic acid, fumaric acid, maleic acid, sorbic acid, alpha-chlorosorbic acid, angelic acid, cinnamic acid, p-chlorocinnamic acid, beta-stearylacrylic acid, citraconic acid, mesaconic acid, glutaconic acid, aconitic acid, tricarboxyethylene, 2-methyl maleic acid, itaconic acid, 2-methyl itaconic acid, methyleneglutaric acid, salts thereof, and mixtures thereof. Embodiment 11 is the coating composition of Embodiment 10, wherein the ethylenically unsaturated acid- or anhydride-functional monomers, including salts thereof, comprise acids selected from acrylic acid, methacrylic acid, crotonic acid, fumaric acid, maleic acid, 2-methyl maleic acid, itaconic acid, 2-methyl itaconic acid, salts thereof, and mixtures thereof. Embodiment 12 is the coating composition of Embodiment 11, wherein the ethylenically unsaturated acid- or anhydride-functional monomers, including salts thereof, comprise acids selected from acrylic acid, methacrylic acid, salts thereof, and mixtures thereof.

Embodiment 13 is the coating composition of any of Embodiments 6 to 12, wherein the ethylenically unsaturated monomer component comprises at least one (meth)acrylate monomer, preferably in an amount of at least 70 wt-%, at least 80 wt-%, or at least 85 wt-%, based on the total weight of the ethylenically unsaturated monomer component. Embodiment 14 is the coating composition of any of Embodiments 6 to 13, wherein the ethylenically unsaturated monomer component comprises at least one (meth)acrylate monomer, preferably in an amount of no more than 95 wt-%, or no more than 90 wt-%, based on the total weight of the ethylenically unsaturated monomer component.

Embodiment 15 is the coating composition of any of Embodiments 6 to 14, wherein the ethylenically unsaturated monomer component comprises at least one (meth)acrylate monomer has the structure (Formula I):

CH₂═C(R¹)—CO—OR² (I)

wherein R¹ is hydrogen or methyl, and R² is an alkyl group (preferably containing 1 to 22, more preferably 1 to 16, or 1 to 12, or 1 to 10 carbon atoms), a cycloaliphatic group (preferably containing 4 to 12 carbon atoms, or 6 to 10 carbon atoms), an aryl group (preferably containing 4 to 15 carbon atoms, or 6 to 10 carbon atoms), or a combination thereof. Embodiment 16 is the coating composition of Embodiment 15, wherein the (meth)acrylate monomers of Formula (I) are selected from methyl (meth)acrylate, ethyl (meth)acrylate, propyl (meth)acrylate, isopropyl (meth)actylate, butyl (meth)acrylate, isobutyl (meth)acrylate, sec-butyl (meth)acrylate, t-butyl (meth)acrylate, pentyl (meth)acrylate, isoamyl (meth)acrylate, hexyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, tridecyl (meth)acrylate, lauryl (meth)acrylate (also referred to as dodecyl (meth)acrylate), cyclohexyl (meth)acrylate, benzyl (meth)acrylate, phenyl (meth)acrylate, isobornyl (meth)acrylate, norbornene (meth)acrylate, tricyclodecenyl (meth)acrylate, hydroxyethyl (meth)acrylate, hydroxypropyl (meth)acrylate, and the like, substituted variants thereof (e.g., ring substituted variants of benzyl (meth)acrylate or phenyl (meth)acrylate), and isomers and mixtures thereof.

Embodiment 17 is the coating composition of Embodiment 15 or 16, wherein the ethylenically unsaturated monomer component comprises at least one linear alkyl (meth)acrylate monomer of Formula (I) having a linear alkyl group. Embodiment 18 is the coating composition of Embodiment 17, wherein the ethylenically unsaturated monomer component includes at least one linear alkyl (meth)acrylate monomer of Formula (I) having a linear (C1-C4)alkyl group. Embodiment 19 is the coating composition of Embodiment 18, wherein the linear alkyl (meth)acrylate monomer is selected from methyl (meth)acrylate, ethyl (meth)acrylate, n-propyl (meth)acrylate, n-butyl (meth)acrylate, and mixtures thereof. Embodiment 20 is the coating composition of Embodiment 19, wherein the linear alkyl (meth)acrylate monomer is selected from ethyl (meth)acrylate.

Embodiment 21 is the coating composition of any of Embodiments 17 to 20, wherein the ethylenically unsaturated monomer component comprises one or more linear alkyl (meth)acrylate monomers in an amount of at least 20 wt-%, at least 30 wt-%, or at least 40 wt-%, based on the total weight of the ethylenically unsaturated monomer component. Embodiment 22 is the coating composition of any of Embodiments 17 to 21, wherein the ethylenically unsaturated monomer component comprises one or more linear alkyl (meth)acrylate monomers in an amount of no more than 80 wt-%, no more than 70 wt-%, no more than 60 wt %, or no more than 50 wt-%, based on the total weight of the ethylenically unsaturated monomer component.

Embodiment 23 is the coating composition of any of Embodiments 15 to 22, wherein the ethylenically unsaturated monomer component comprises at least one cyclic and/or branched (meth)acrylate monomer of Formula (I) having a cyclic and/or branched group. Embodiment 24 is the coating composition of Embodiment 23, wherein the cyclic and/or branched (meth)acrylate monomer is selected from isopropyl (meth)acrylate, isobutyl (meth)acrylate, sec-butyl (meth)acrylate, t-butyl (meth)acrylate, isoamyl (meth)acrylate, 2-ethylhexyl (meth)acrylate, isooctyl (meth)acrylate, isononyl (meth)acrylate, isodecyl (meth)acrylate, tridecyl (meth)acrylate, cyclohexyl (meth)acrylate, benzyl (meth)acrylate, isobornyl (meth)acrylate, norbornene (meth)acrylate, tricyclodecenyl (meth)acrylate, and mixtures thereof. Embodiment 25 is the coating composition of Embodiment 24, wherein the cyclic and/or branched (meth)acrylate monomer is selected from cyclohexyl (meth)acrylate.

Embodiment 26 is the coating composition of any of Embodiments 23 to 25, wherein the ethylenically unsaturated monomer component comprises one or more cyclic and/or branched alkyl (meth)acrylate monomers in an amount of at least 10 wt-%, at least 15 wt-%, or at least 20 wt-%, based on the total weight of the ethylenically unsaturated monomer component. Embodiment 27 is the coating composition of any of Embodiments 23 to 26, wherein the ethylenically unsaturated monomer component comprises one or more cyclic and/or branched alkyl (meth)acrylate monomers in an amount of no more than 50 wt-%, no more than 45 wt-%, no more than 40 wt-%, no more than 35 wt-%, or no more than 30 wt-%, based on the total weight of the ethylenically unsaturated monomer component.

Embodiment 28 is the coating composition of any of Embodiments 6 to 27, wherein the acrylic latex is formed from polymerization of an ethylenically unsaturated monomer component comprises at least one multi-ethylenically-unsaturated (meth)acrylate monomer. Embodiment 29 is the coating composition of Embodiment 28, wherein the ethylenically unsaturated monomer component comprises one or more multi-ethylenically-unsaturated (meth)acrylate monomers in an amount of at least 5 wt.-% or at least 10 wt-%, based on the total weight of the ethylenically unsaturated monomer component. Embodiment 30 is the coating composition of Embodiment 28 or 29, wherein the ethylenically unsaturated monomer component comprises one or more multi-ethylenically-unsaturated (meth)acrylate monomers in an amount of no more than 25 wt-%, no more than 20 wt-%, no more than 15 wt-%, no more than 10 wt-%, no more than 5 wt-%, or no more than 1 wt-%, based on the total weight of the ethylenically unsaturated monomer component.

Embodiment 31 is the coating composition of any of Embodiments 6 to 27, wherein the ethylenically unsaturated monomer component does not contain any multi-ethylenically; unsaturated (meth)acrylate monomers. Embodiment 32 is the coating composition of Embodiment 31, Wherein the ethylenically unsaturated monomer component does not contain any multi-functional crosslinking monomers.

Embodiment 33 is the coating composition of any of Embodiments 6 to 32, wherein the acrylic latex is formed from polymerization of an ethylenically unsaturated monomer component further comprising at least one oxirane-functional monomer. Embodiment 34 is the coating composition of Embodiment 33, wherein the oxirane-functional monomer is not glycidyl acrylate or glycidyl methacrylate. Embodiment 35 is the coating composition of Embodiment 33 or 34, wherein the ethylenically unsaturated monomer component comprises one or more oxirane-functional monomers in an amount of no more than 30 wt-%, no more than 20 wt-%, no more than 10 wt-%, or no more than 9 wt-%, based on the total weight of the ethylenically unsaturated monomer component. Embodiment 36 is the coating composition of any of Embodiments 33 to 35, wherein the ethylenically unsaturated monomer component comprises one or more oxirane-functional monomers in an amount of at least 1 wt-%, at least 2 wt-%, at least 3 wt-%, or at least 5 wt-%, based on the total weight of the ethylenically unsaturated monomer component.

Embodiment 37 is the coating composition of any of Embodiments 6 to 32, wherein the ethylenically unsaturated monomer component does not include any monomers haying oxirane groups. Embodiment 38 is the coating composition of any preceding Embodiment, wherein the acrylic latex, and preferably the overall coating composition, is substantially free of, completely free of, or does not contain glycidyl acrylate and glycidyl methacrylate monomers (whether free or polymerized). Embodiment 39 is the coating composition of any preceding Embodiment, wherein the acrylic latex, and preferably the overall coating composition, is substantially free of, completely free of, or does not contain any (meth)acrylamide-type monomers (e.g., acrylamides or methacrylamides, N-isobutoxymethyl acrylamide, N-butoxymethyl acrylamide) or structural units derived therefrom.

Embodiment 40 is the coating composition of any of Embodiments 6 to 39, wherein the ethylenically unsaturated monomer component is free of styrene. Embodiment 41 is the coating composition of any preceding Embodiment, wherein the coating composition is free of styrene. Embodiment 42 is the coating composition of any preceding Embodiment, wherein the acrylic latex, and preferably the overall coating composition, is substantially free of, completely free of, or does not contain vinyl aromatic monomers (whether free or polymerized).

Embodiment 43 is the coating composition of any of Embodiments 6 to 43, wherein the ethylenically unsaturated monomer component does not include any halogenated monomers, such as chlorinated vinyl monomers. Embodiment 44 is the coating composition of any preceding Embodiment, wherein the acrylic latex, and preferably the overall coating composition, is substantially free of, completely free of, or does not contain halogenated monomers (whether free or polymerized).

Embodiment 45 is the coating composition of any of Embodiments 6 to 44, wherein the ethylenically unsaturated monomer component comprises one or more adhesion-promoting monomers. Embodiment 46 is the coating composition of any of Embodiments 6 to 45, wherein the ethylenically unsaturated monomer component comprises one or more hydroxy-functional monomers.

Embodiment 47 is the coating composition of any of Embodiments 6 to 46, wherein the ethylenically unsaturated monomer component comprises: (i) at least one of acrylic acid or methacrylic acid; (ii) at least one of ethyl acrylate or n-butyl acrylate; and (iii) a cyclic monomer. Embodiment 48 is the coating composition of Embodiment 47, wherein the ethylenically unsaturated monomer component comprises acrylic acid, ethyl acrylate, and cyclohexyl methacrylate (CHMA).

Embodiment 49 is the coating composition of any preceding Embodiment, which includes less than 1 wt-%, by weight total solids, of a crosslinker derived from formaldehyde, if any. Embodiment 50 is the coating composition of Embodiment 49, which is substantially free of, completely free of, or does not contain a crosslinker derived from formaldehyde. Embodiment 51 is the coating composition of any preceding Embodiment, which is formaldehyde-free.

Embodiment 52 is the coating composition of any preceding Embodiment, which does not include any intentionally added bisphenol components (such as bisphenol A, bisphenol S. or bisphenol F). Embodiment 53 is the coating composition of any preceding Embodiment, which is epoxy-free.

Embodiment 54 is the coating composition of any preceding Embodiment, wherein the emulsion polymerized polymer of the acrylic latex has a number average molecular weight (Mₙ) of greater than 20,000, greater than 30,000, greater than 100,000, greater than 200,000, or greater than 300,000. Embodiment 55 is the coating composition of any preceding Embodiment, wherein the emulsion polymerized polymer of the acrylic latex has an Mₙ of less than 1,000,000, less than 600,000, or less than 400,000.

Embodiment 56 is the coating composition of any preceding Embodiment, wherein the acrylic latex has a Tg of at least 0° C., at least 5° C., at least 10° C., at least 15° C., at least 20° C., or at least 25° C., as determined by DSC, and a Tg of no higher than 50° C., no higher than 45° C., no higher than 40° C. no higher than 35° C., no higher than 30° C., or no higher than 25° C., as determined by DSC.

Embodiment 57 is the coating composition of any preceding Embodiment, wherein the coating composition forms a cured coating having a Tg of from 15° C. to 45° C., as determined by DSC. Embodiment 58 is the coating composition of any preceding Embodiment, wherein the coating composition forms a cured coating having a Tg of from 20° C. to 40° C., as determined by DSC.

Embodiment 59 is the coating composition of any preceding Embodiment, comprising at least 50 wt-%, at least 65 wt-%, at least 80 wt-%, or at least 90 wt-%, of the acrylic latex, based on the total solids weight of the coating composition. Embodiment 60 is the coating composition of any preceding Embodiment, comprising less than 99 wt-%, or less than 95 wt-% of the acrylic latex, based on the total solids weight of the coating composition.

Embodiment 61 is the coating composition of any preceding Embodiment, wherein the nitrogen-containing carboxyl-reactive crosslinker comprises two or more carboxyl-reactive functional groups. Embodiment 62 is the coating composition of any preceding Embodiment, wherein the carboxyl-reactive crosslinker comprises hydroxyl groups. Embodiment 63 is the coating composition of Embodiment 62, wherein the carboxyl-reactive crosslinker comprises two or more, three or more, or four or more hydroxyl groups. Embodiment 64 is the coating composition of Embodiment 63, wherein the carboxyl-reactive crosslinker includes at least four hydroxyl groups.

Embodiment 65 is the coating composition of any of Embodiments 62 to 64, wherein the crosslinker has a hydroxyl number of at least 100, at least 200, at least 300, at least 400, or at least 500 mg KOH/g resin.

Embodiment 66 is the coating composition of any preceding Embodiment, wherein the acrylic latex and the carboxyl-reactive crosslinker are present in the coating composition in amounts to provide an excess of carboxyl (—COOH and neutralized such groups) equivalents in the acrylic latex relative to hydroxyl (—OH) equivalents in the crosslinker. Embodiment 67 is the coating composition of Embodiment 66, wherein the acrylic latex and the carboxyl-reactive crosslinker are present in the coating composition in a ratio of molar equivalents of carboxyl groups in the acrylic latex to hydroxyl groups in the crosslinker of at least 1.5:1, or preferably at least 2:1 (e.g., COOH groups and/or salts thereof, to OH groups). Embodiment 68 is the coating composition of Embodiment 66 or 67, wherein the acrylic latex and the carboxyl-reactive crosslinker are present in the coating composition in a ratio of molar equivalents of carboxyl groups in the acrylic latex to hydroxyl groups in the crosslinker of up to 6:1, or up to 5:1 (e.g., COOH groups and/or salts thereof, to OH groups).

Embodiment 69 is the coating composition of any preceding Embodiment, comprising at least 0.5 wt-%, at least 1 wt-%, at least 1.5 wt-%, at least 2 wt-%, at least 2.5 wt-%, or at least 3 wt-% of the carboxyl-reactive crosslinker, based on total solids weight of the coating composition. Embodiment 70 is the coating composition of any preceding Embodiment, comprising less than 30 wt-%, less than 20 wt-%, less than 15 wt-%, less than 10 wt-%, or less than 7 wt-% of the crosslinker, based on total solids weight of the coating composition.

Embodiment 71 is the coating composition of any preceding Embodiment, wherein the carboxyl-reactive crosslinker comprises two or more nitrogen atoms, and, in some embodiments, two total nitrogen atoms. Embodiment 72 is the coating composition of Embodiment 71, wherein the carboxyl-reactive crosslinker comprises at least one amide group, at least one imide group, or combinations thereof. Embodiment 73 is the coating composition of Embodiment 72, wherein the carboxyl-reactive crosslinker comprises a beta-hydroxyl group relative to a nitrogen atom of an amide bond. Embodiment 74 is the coating composition of Embodiment 73, wherein the carboxyl-reactive crosslinker comprises one or more, and more preferably two or more, groups having the structure of Formula (III):

HO—R³—N(R⁶)—C(═O)— (III)

wherein each R⁵ is independently an organic group, and each R⁶ is independently hydrogen or an organic group. Embodiment 75 is the coating composition of Embodiment 74, wherein the carboxyl-reactive crosslinker is a compound having the structure of Formula (V):

(HO—R⁵—N(R⁶)—C(═O))ₙ—X (V)

wherein R⁵ and R⁶ are as described for Formula n is an integer of 2 or more, and X is a polyvalent organic group. Embodiment 76 is the coating composition of Embodiment 74, wherein the carboxyl-reactive crosslinker is a compound having the structure of Formula (VI):

HO—R⁵—N(R⁶)—C(═O)—X—C(═O)—N(R⁶)—(R⁵)—OH (VI)

wherein R⁵ and R⁶ of Formula (VI) are independently organic groups, X is a bivalent organic group, and wherein the hydroxyl groups are independently primary or secondary hydroxyl groups. Embodiment 77 is the coating composition of Embodiment 74, wherein the carboxyl-reactive crosslinker comprises a compound of Formula (VII):

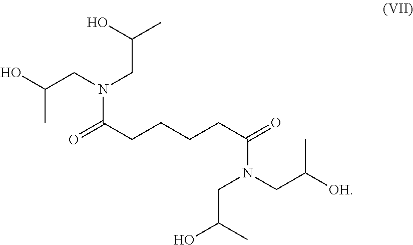 [SMILES: CC(O)CN(CC(C)O)C(=O)CCCCC(=O)N(CC(C)O)CC(C)O]

Embodiment 78 is the coating composition of any of Embodiments 1 to 70, wherein the carboxyl-reactive crosslinker comprises a carbodiimide crosslinker. Embodiment 79 is the coating composition of any of Embodiments 1 to 70, wherein the carboxyl-reactive crosslinker comprises an aziridine crosslinker. Embodiment 80 is the coating composition of any of Embodiments 1 to 70, wherein the carboxyl-reactive crosslinker comprises an oxazoline crosslinker.

Embodiment 81 is the coating composition of any preceding Embodiment, comprising a mixture of crosslinkers, wherein the mixture of crosslinkers comprises more than 50 wt-%, more than 66 wt-%, or more than 80 wt-%, of the nitrogen-containing carboxyl-reactive crosslinker, based on the total weight of the crosslinker.

Embodiment 82 is the coating composition of any preceding Embodiment, further comprising a lubricant, wherein the lubricant is incorporated within the coating composition or applied to the coating composition after the coating composition is applied to a substrate. Embodiment 83 is the coating composition of Embodiment 82, wherein the lubricant is selected from carnauba wax, Fischer-Tropsch wax, fatty acid ester wax, silicon-based wax, lanolin wax, hydroxy functional polysiloxane wax, polytetrafluoroethylene (PTFE) wax, polyolefin wax (e.g., polyethylene (PE) wax, polypropylene (PP) wax, and high-density polyethylene (HDPE) wax), amide wax (e.g., micronized ethylene-bis-stearamide (EBS) wax), combinations thereof, and modified version thereof (e.g., amide-modified PE wax, PTFE-modified PE wax, and the like). Embodiment 84 is the coating composition of

Embodiment 82 or 83, wherein the lubricant is a PTFE-free lubricant (i.e., those that do not contain polytetrafluoroethylene). Embodiment 85 is the coating composition of Embodiment 84, which is free of any lubricants made using fluorine-containing ingredients. Embodiment 86 is the coating composition of any of Embodiments 82 to 85, wherein one or more lubricants are present in the coating composition in an amount of at least 0.1 wt-%, at least 0.25 w4-%, at least 0.5 wt-%, or at least 0.75 wt-%, based on the total weight of solids in the coating composition. Embodiment 87 is the coating composition of any of Embodiments 82 to 86, wherein one or more lubricants are present in the coating composition in an amount of no greater than 3 wt-%, no greater than 2 wt-%, no greater than 1.5 wt-%, no greater than 1.25 wt-%, or no greater than 1 wt-%, based on the total weight of solids in the coating composition.

Embodiment 88 is the coating composition of any preceding Embodiment, further comprising one or more ingredients selected from pigments, extenders, fillers, anticorrosion agents, flow control agents, thixotropic agents, dispersing agents, antioxidants, adhesion promoters, light stabilizers, surfactants, and mixtures thereof. Embodiment 89 is the coating composition of any preceding Embodiment 88 (except for Embodiment 53), further comprising one or more secondary polymers selected from polyolefins, polyesters, polyurethanes, polyethers, and copolymers thereof. Embodiment 90 is the coating composition of Embodiment 89. wherein the one or more secondary polymers, if present, are present in an amount, based on total resin solids, of no more than 20 wt-%, no more than 10 wt-%, no more than 5 wt-%, or no more than 1 wt-%, if any.

Embodiment 91 is the coating composition of any preceding Embodiment comprising 10 wt-% to 50 wt-%, preferably 20 wt -% to 40 wt-%, and more preferably 30 wt-% to 40 wt-% total non-volatile solids, based on the total weight of the coating composition.

Embodiment 92 is the coating composition of any preceding Embodiment, which has a viscosity at 25° C. measured via ASTM D-1200 of 30 seconds to 80 seconds, or 35 seconds to 60 seconds, using a number Ford #2 cup.

Embodiment 93 is the coating composition of any preceding Embodiment, further comprising a carrier fluid. Embodiment 94 is the coating composition of any preceding Embodiment, comprising at least 10 wt-%, at least 20 wt-%, at least 25 wt-%, at least 35 wt-%, or at least 50 wt -% of water, based on the total weight of the coating composition. Embodiment 95 is the coating composition of Embodiment 93 or 94, wherein the carrier fluid includes one or more organic solvents, preferably one or more water-miscible organic solvents. Embodiment 96 is the coating composition of Embodiment 95, wherein the organic solvent comprises isopropyl alcohol, ethanol, methanol, butyl alcohol, amyl alcohol, dials, glycol ethers, glycol esters, acetone, methyl ethyl ketone, or tetrahydrofuran, or mixtures thereof.

Embodiment 97 is the beverage can end coil coating composition of any preceding Embodiment, wherein the coating composition is an aqueous coating composition that includes at least 5 weight percent of one or more organic solvents. Embodiment 98 is the coating composition of Embodiment 97, comprising at least 5 wt-%, at least 10 wt-%, or at least 15 wt-% of one or more organic solvents, based on the total weight of the coating composition.

Embodiment 99 is the coating composition of any preceding Embodiment, wherein the coating composition: includes lubricant; includes at least 50 wt -% of the acrylic latex, based on the total solids weight of the coating composition; includes at least 5 wt-% of one or more organic solvents, based on the total weight of the coating composition; and includes 30 wt.-% to 40 wt-% total non-volatile solids content, based on the total weight of the composition.

Embodiment 100 is the coating composition of any preceding Embodiment, wherein when applied to a cleaned and chrome-free pretreated aluminum panel and cured for 12 seconds to a peak metal temperature of 249° C. to achieve a dried film thickness of approximately 11 grams per square meter and formed into a fully converted (typically, 206) standard opening beverage can end, passes less than 2 milliamps of current, or less than 1 milliamp of current, while being exposed for 4 seconds to an electrolyte solution containing 1% by weight of NaCl dissolved in deionized water.

Embodiment 101 is the coating composition of any preceding Embodiment, wherein a coating prepared from such composition, when applied to a cleaned and chrome-free, zirconium-pretreated aluminum panel and cured for 12 seconds to a peak metal temperature of 249° C. to achieve a dried film thickness of approximately 11 (i.e., 10-12) grams per square meter, and preferably formed into a fully converted (typically, 206) standard opening beverage can end, displays one or more of the following properties (and in some embodiments all properties or various combinations of such properties): MEK solvent resistance of at least 30 double rubs; a blush rating after water pasteurization of at least 6; an adhesion rating of GT0 or GT; and feathering, if any, of 0.5 mm or less, 0.4 mm or less, 0.3 mm or less, 0.2 mm or less, or 0.1 mm or less, or none.

Embodiment 102 is the coating composition of any preceding Embodiment, which is spray dried and in the form of a powder coating composition.

Embodiment 103 is a method comprising: providing a coating composition of any preceding Embodiment; applying the coating composition (e.g., via roll coating) to a substrate comprising a beverage can end steel or aluminum coil; healing the coated substrate in an oven for 6 to 30 seconds of oven residence time to achieve a peak metal temperature of 200° C. to 260° C.; and optionally fabricating (e.g., stamping) the coated coil to form an easy open beverage can end.

Embodiment 104 is the method of Embodiment 103, wherein applying coating composition to the surface of the substrate includes applying the coating composition on a continuously moving surface traveling at a line speed of 50 meters per minute to 400 meters per minute.

Embodiment 105 is a coated article comprising a beverage can end having an interior or exterior coating, or both formed from the coating composition of any of Embodiments 1 to 104, or resulting from the method of Embodiment 105 or 106.

Embodiment 106 is the method or article of any of Embodiments 103 to 105, wherein the coating has an average dry coating thickness of 7 micrometers to 15 micrometers.

Embodiment 107 is the method or article of any of Embodiments 103 to 106, wherein the metal substrate has an average thickness of 175 to 250 micrometers. Embodiment 108 is the method or article of any of Embodiments 103 to 107, wherein a surface of the metal substrate is pretreated with a chromium-based or non-chromium-based (e.g., zirconium and acrylic-based) treatment prior to coating with the coating composition.

Embodiment 109 is a method comprising causing the aqueous coating composition of any of Embodiments 1 to 102 to be used on a metal substrate of metal packaging.

### EXAMPLES

The following examples are given to illustrate, but not limit, the scope of this invention. Unless otherwise indicated in the Examples and throughout this disclosure, all parts, ratios, and percentages are by weight and all molecular weights are weight average molecular weight. Unless otherwise specified, all chemicals used are commercially available from, for example, Sigma-Aldrich (St. Louis, MO). One or more of the following test methods are used within the following Examples.

### Test Methods

Solvent Resistance: The extent of “cure” or crosslinking of a coating is measured as a resistance to solvents, such as methyl ethyl ketone (MEK). This test is performed as described in ASTM D 5402-91 The number of double-rubs (i.e., one back-and-forth motion) is reported, Preferably, the MEK solvent resistance is at least 30 double rubs, preferably at least 50 double rubs, and more preferably, at least 100 double rubs. Blush Resistance: Blush resistance measures the ability of a coating to resist attack by various solutions after pasteurization or retort. Typically, blush is measured by the amount of water absorbed into a coated film. When the film absorbs water, it generally becomes cloudy or looks white. Blush is generally measured visually using a scale of 0 to 10 where a rating of “10” indicates no blush and a rating of “0” indicates complete whitening of the film. Blush ratings after retort (as described herein) of at least 6 are preferred and 7 or above are more preferred, and 9 or above are most preferred.

Adhesion: Adhesion testing is performed to assess whether the coating adheres to the coated substrate. The adhesion test was performed either according to DIN 53151 (Deutsches Institut für Normung e.V. 10772 Berlin, Germany) using SCOTCH 610 tape. Adhesion is generally rated on a scale of GTO-GTS where a rating of “GT0” indicates no adhesion failure, a rating of “GT2” indicates 85% of the coating remains adhered, a rating of “GT3” indicates 65-85% of the coating remains adhered, and so on. Adhesion ratings of GT0 or GT1 are typically desired for commercially viable coatings.

Water Retort: For the evaluations herein, a coated substrate was immersed in deionized water and subjected to heat of 121° C., and a corresponding pressure to achieve such temperature, for a period of 90 minutes. The coating was then subjected to blush resistance and adhesion testing.

Glass Transition Temperature (“Tg”): For evaluating the Tg of the acrylic latex, samples for differential scanning calorimetry (“DSC”) testing may be prepared by measuring 40 mg of liquid samples into a DSC pan and heating to 150° C. in an oven for 1 hour. All samples were analyzed by DSC under the following experimental conditions: 1-Equilibrate temperature at −50° C.; 2-Ramp: 20° C./min to 150° C. (end of Cycle 1); 3-Equilibrate temperature at −50° C.; 4-Ramp: 20° C./min to 200° C. (end of Cycle 2); 5-Equilibrate temperature at −50° C.; 6-Ramp: 20° C./min to 200° C. (end of Cycle 3).

For evaluating the Tg of cured coatings, an aqueous coating composition is applied to a cleaned and chrome-free, zirconium-pretreated aluminum panel and cured for 12 seconds oven cure time to a peak metal temperature of 249° C. to achieve a dried film thickness of approximately 11 grams per square meter (i.e., 10-12 gsm). After cooling to room temperature, the samples are scraped from the panels, weighed into standard sample pans and analyzed using the standard DSC heat-cool-heat method. Samples for testing were scraped from the panels and analyzed by DSC under the following experimental conditions: 1-Equilibrate temperature at −50° C.; 2-Ramp: 20° C./min to 150° C. (end of Cycle 1); 3-Equilibrate temperature at −50° C.; 4-Ramp: 20° C./min to 200° C. (end of Cycle 2); 5-Equilibrate temperature at −50° C.; 6-Ramp: 20° C./min to 200° C. (end of Cycle 3).

Glass transitions are calculated from the thermogram of the last heat cycle. The glass transition is measured at the inflection point of the transition.

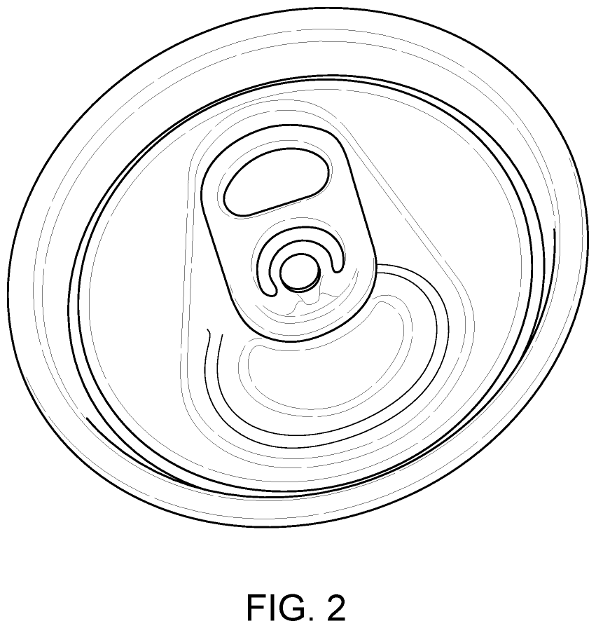

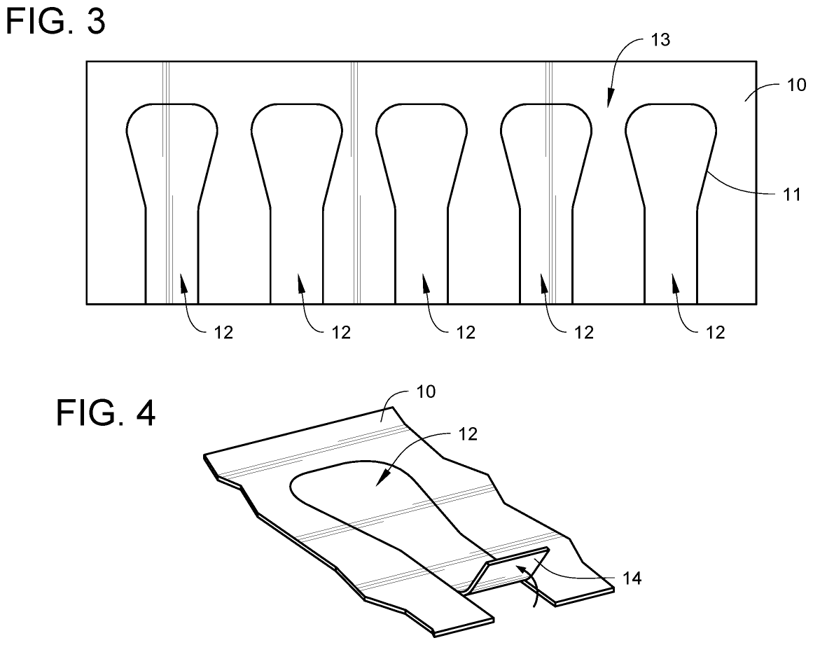

Feathering: As shown in FIGS. 3 to 6, feathering is measured using a 0.226 mm gauge coated aluminum reference sheet 10, a score tool having a 60 micron score width set up in a Carver press (or equivalent), a 7× magnifier graduated in increments of 0.005 inches (or equivalent), an optional 6 inch vice, a 2000 mL beaker (or equivalent), and a thermometer. The sample to be tested is prepared by cutting a 2 inch by 6 inch sheet 10 from the area to be tested. The 2 inch cut must be in the rolling direction (with the grain of the metal). Using a permanent marker, a straight line may be made along the entire 6 inch edge of the product side for reference in forming simulated tabs. Using the permanent marker, a VI inch straight-line mark is made ½ inch in from the top edge of the test sample on the product side, then five additional ¼ inch straight-line marks are made 1 inch apart along the 6 inch width of the sample to help space out the simulated tabs.

For testing, the sheet 10 (coated or product side up) is placed between the score tool and the anvil in the Carver press. The first ¼ inch line on the sample is matched up with the black line on the score tool. The bottom edge of the sample should be aligned flush against a guide block on the inside of the press. Manually jack the press lever until a force of 5 metric tons registers on the hydraulic pressure gauge to form a score line 11 producing a simulated tab 12. The sheet 10 is then indexed to the second black line at the top edge of the sample. Again, jack the press lever until a force of 5 metric tons registers on the hydraulic pressure gauge to form another score line 11 producing a second simulated tab 12. Repeat to make a total of five simulated tabs 12 along the 6 inch width as generally shown in FIG. 3. Next, either manually or by using a pair of small shears, cut or tear a portion 14 of the simulated tabs 12 for approximately ¼ inch as generally shown in FIG. 4. The tab portion 14 may be bent upward 90 degrees.

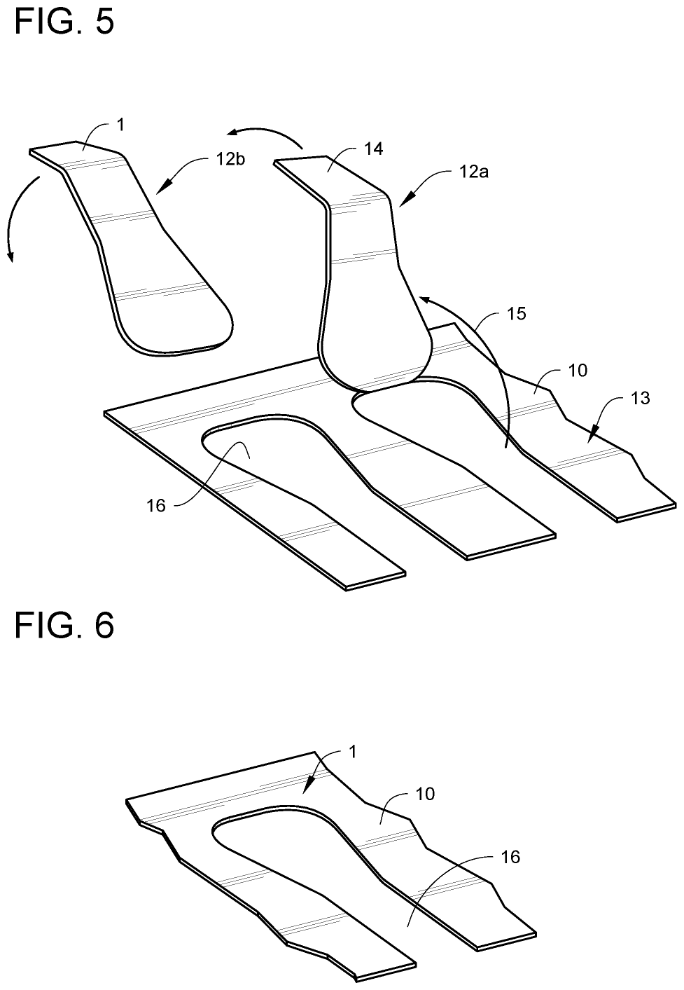

Next, the sheet 10 is conditioned, such as by submerging the test sample upright (that is the “legs” facing up) into a water bath as needed for the selected suitable testing such the beaker and thermometer as needed. Typically, conditioning is 45 minutes at 85° C. in deionized (DI) water followed by a cool down with tap water before further testing. Other processing conditions may be used as needed for a particular application. For the evaluation of feathering, one sheet 10 at a time is evaluated by drying each one before testing. First, the sheet 10 is turned so that the coating side 13 is facing the operator. The scored legs 14 of each simulated tab is upward at a 90° angle back toward the operator. The sheet 10 is then placed on a flat surface (adhesive tape or other fastening method (i.e. vice) may be used if necessary to fix a panel edge on the surface). A pair of pliers or other device (not shown) is then used to pull 15 each simulated tab 12 straight back towards the operator (parallel to the floor) to completely remove the tab from the test sample. FIG. 5 shows simulated tab 12a in the process of being pulled and simulated tab 12b removed from the sheet 10. After pulling all five simulated tabs, feathering is measured on the end 18 of the formed opening 16 of the sample 10 using, for instance, the 7× ocular marked in increments of 0.005 inches as generally shown in FIG. 6. Feathering is determined by calculating the average of all five values on each sheet 10.

Coatings for easy-open beverage can ends preferably show feathering below 0.5 mm, more preferably below 0.4 mm, most preferably below 0.3 mm, and optimally 0.2 mm or even less feathering. Certain preferred films of this disclosure, when suitably cured, exhibited a feathering of 0.1 mm or less when tested as described above and when subjected to the short cure cycles noted herein.

Porosity: A beverage can end is prepared as follows: the aqueous coating compositions is applied to a cleaned and chrome-free, zirconium-pretreated aluminum panel and cured for 12 seconds oven cure time to a peak metal temperature of 249° C. to achieve a dried film thickness of approximately 11 grams per square meter (i.e., 10-12 gsm) and formed into a fully converted 206 standard opening beverage can end.

The Porosity Test is conducted by placing a coated beverage can end on a cup filled with an electrolyte solution. The cup is inverted to expose the interior coated surface of the can end to the electrolyte solution, The amount of electrical current that passes through the end is then measured. If the coating remains intact (no cracks or fractures) after fabrication, minimal current will pass through the end. Fax the present evaluation, fully converted standard opening can ends (which are “riveted” aluminum beverage can ends) are exposed for a period of 4 seconds to an electrolyte solution containing 1% NaCl by weight in deionized water. Metal exposures are measured using a WACO Enamel Rater II, available from the Wilkens-Anderson Company, Chicago, IL, with an output voltage of 6.3 volts. The measured electrical current is reported in milliamps. End continuities are typically tested initially and then after the ends are subjected to either pasteurization or retort. A coating is considered to satisfy the Porosity Test if it passes an electric current (after end formation) of less than 10 milliamps (mA) when tested as described above. Preferred coatings pass the initial test with less than 5 milliamps (mA), more preferably less than 2 mA, and even more preferably less than 1 mA. Preferred coatings pass the porosity test after pasteurization with less than 10 mA, more preferably less than 8 mA, and even more preferably less than 5 mA.

Viscosity Test: This test measures the viscosity of a coating composition for rheological purposes, such as for efficient roll coating application without defects, and other coating application properties. The test is performed pursuant to ASTM D1200-88 using a Ford Viscosity Cup 42 at 25° C. The results are measured in the units of seconds.

### Example 1

An acrylic latex seed polymer was prepared using the materials included in Table 1.

TABLE 1
Seed Polymer

| | Raw Materials | Weight | % |
|---|---|---|---|
| 1 | Water | 817.68 | 40.884% |
| 2 | GLYCOSPERSE L-20KFG Polysorbate | 6.59 | 0.330% |
| | 20 Nonionic Surfactant | | |
| 3 | AEROSOL OT-70-PG Sulfosuccinate- | 8.71 | 0.436% |
| | based Anionic Surfactant | | |
| 4 | Isoascorbic Acid Accelerator | 0.47 | 0.024% |
| 5 | Iron Sulfate Heptahydrate Promoter | 0.00237 | 0.000% |
| 6 | Water | 23.74 | 1.187% |
| 7 | GLYCOSPERSE L-20KFG Polysorbate | 7.54 | 0.377% |
| | 20 Nonionic Surfactant | | |
| 8 | AEROSOL OT-70-PG Sulfosuccinate- | 10.13 | 0.506% |
| | based Anionic Surfactant | | |
| 9 | Water | 306.38 | 15.319% |
| 10 | Ethylacrylate (EA) | 246.09 | 12.305% |
| 11 | Cyclohexylmethacrylate (CHMA) | 336.73 | 16.836% |
| 12 | Acrylic acid (AA) | 30.74 | 1.537% |
| 13 | LUPEROX TAH 85 Tert-amyl | 0.84 | 0.042% |
| | Hydroperoxide Polymerization Initiator | | |
| 14 | AEROSOL OT-70-PG Sulfosuccinate- | 0.38 | 0.019% |
| | based Anionic Surfactant | | |
| 15 | Water | 77.73 | 3.886% |
| 16 | Water | 37.14 | 1.857% |
| 17 | Water | 37.14 | 1.857% |
| 18 | LUPEROX TAH 85 Tert-amyl | 1.00 | 0.050% |
| | Hydroperoxide Polymerization Initiator | | |
| 19 | Isoascorbic Acid Accelerator | 0.5123 | 0.026% |
| 20 | Iron Sulfate Heptahydrate Promoter | 0.00502 | 0.0003% |
| 21 | Water | 50.44 | 2.522% |
| | TOTAL | 2000.00 | 100.000% |
| | Dry content | 643.70 | 32.185% |

### Process of Making Seed

The seed was prepared as follows.

A monomer premix was prepared by combining raw materials 7 to 9 in an Erlenmeyer flask and stirring for 10 minutes. The monomers from 10 to 12 were added successively under stirring, performing a 5-minute hold between each addition of monomer. The final premix was held under stirring for 45 minutes before using it.

Raw materials 1 to 3 were loaded in a round-bottomed vessel equipped with a condenser, a mechanical stirrer, and a temperature probe, and heated to 80° C. Raw materials 5 and 6 were premixed, and added to the vessel with raw material 4 while holding the temperature at 80° C.

Simultaneously and separately, the monomer premix (including raw materials 7 to 12) and the initiator premix (raw materials 13 to 15) were added to the vessel over 180 minutes. Two feeding lines were flushed with raw materials 16 and 17. The reaction mixture was held for 60 minutes at 80° C. At the end of the hold, raw material 18 was added to the vessel and then the spike premix (raw materials 19 to 21) was added over 60 minutes. The reaction mixture was again held for 60 minutes at 80° C. At the end of the hold, the reaction mixture was cooled down to 35° C. under stirring.

The final characteristics of the seed polymer were: nonvolatile material (NVM) (@180° C.)=31%; Acid Value (AV)=37.7; pH=3; Viscosity @25° C. (Ford #4 cup)=15 seconds; particle size distribution (PSD) (Microtrac)=70 nm.

### Example 2

An acrylic latex was prepared using the materials included in Table 2.

TABLE 2
Acrylic Latex

| | Raw Materials | Weight | % |
|---|---|---|---|
| 1 | Seed Polymer | 1018.46 | 25.46% |
| 2 | Water | 977.78 | 24.44% |
| 3 | Isoascorbic Acid Accelerator | 2.38 | 0.06% |
| 4 | Iron Sulfate Heptahydrate Promoter | 0.01248 | 0.0003% |
| 5 | Water | 124.86 | 3.12% |
| 6 | Water | 1048.16 | 26.20% |
| 7 | GLYCOSPERSE L-20KFG Polysorbate | 29.40 | 0.73% |
| | 20 Nonionic Surfactant | | |
| 8 | AEROSOL OT-70-PG Sulfosuccinate- | 38.80 | 0.97% |
| | based Anionic Surfactan | | |
| 9 | Ethylacrylate (EA) | 1392.06 | 34.80% |
| 10 | Cyclohexylmethacrylate (CHMA) | 435.00 | 10.87% |
| 11 | Acrylic acid (AA) | 268.87 | 6.72% |
| 12 | LUPEROX TAH 85 Tert-amyl | 3.52 | 0.09% |
| | Hydroperoxide Polymerization Initiator | | |
| 13 | AEROSOL OT-70-PG Sulfosuccinate- | 1.59 | 0.04% |
| | based Anionic Surfactan | | |
| 14 | Water | 198.18 | 4.95% |
| 15 | Water | 126.84 | 3.17% |
| 16 | Water | 126.84 | 3.17% |
| 17 | LUPEROX TAH 85 Tert-amyl | 4.27 | 0.11% |
| | Hydroperoxide Polymerization Initiator | | |
| 18 | Isoascorbic Acid Accelerator | 2.0370 | 0.05% |
| 19 | Iron Sulfate Heptahydrate Promoter | 0.02007 | 0.0005% |
| 20 | Water | 200.89 | 5.02% |
| | TOTAL | 4000.00 | 100.00% |
| | Dry content | 1652.84 | 41.32% |

### Process of Making Acrylic Latex

The acrylic latex was prepared as follows.

A monomer premix was prepared by combining raw materials 6 to 8 in an Erlenmeyer flask and stirring for 10 minutes. The monomers from 9 to 11 were added successively under stirring, performing a 5-minute hold between each addition of monomer. The final premix was held under stirring for 45 minutes before using it.

Raw materials 1 and 2 were loaded in a round-bottomed vessel equipped with a condenser, a mechanical stirrer, and a temperature probe, and heated to 80° C. Raw materials 4 and 5 were premixed, and added to the vessel with raw material 3 while holding the temperature at 80° C.

Simultaneously and separately, the monomer premix (including raw materials 6 to 11) and the initiator premix (raw materials 12 to 14) were added to the vessel over 180 minutes. Two feeding lines were flushed with raw materials 15 and 16. The reaction mixture was held for 60 minutes at 80° C. At the end of the hold, raw material 17 was added to the vessel and then the spike premix (raw materials 18 to 20) was added over 60 minutes. The reaction mixture was again held for 60 minutes at 80° C. At the end of the hold, the reaction mixture was cooled down to 35° C. under stirring.

The final characteristics of the acrylic latex were: NVM (@180° C.)=41.6%; AV=86; pH=2.8; Viscosity @25° C. (Ford #2 cup)=37 seconds; PSD (Microtrac)=136 nm; and Tg measured by DSC=22° C.

### Example 3

The acrylic latex of Example 2 was formulated into aqueous coil coating compositions using the ingredients indicated in Table 3.

TABLE 3

| Raw Materials | Wt-% (on wet) | Wt-% (on solids) |
|---|---|---|
| Acrylic Latex of Example 2 | 69.06% | 94.63% |
| Neutralizant -- Dimethylethanol | 0.59% | — |
| Amine (DMEA) | | |
| Crosslinker -- PRIMID QM1260 | 3.17% | 4.18% |
| Hydroxyalkylamide (40 wt-% | | |
| solution) | | |
| Solvent - Isopropanol (3%) and | 8% | — |
| Propylene Glycol (5%) | | |
| Lubricant -- Carnauba Wax | 1.45% | 1.19% |
| Deionized Water | 17.72% | — |

### Formulation Process

The coil coating composition including an acrylic latex COOH to crosslinker OH molar equivalent ratio of 3:1 was prepared using a neutralization rate of 15% (which is the percentage of COOH groups that can be neutralized with the amount of neutralizer added) as follows.

A crosslinker premix was prepared by adding the PRIMID crosslinker (40 wt-% solution) and deionized water (60% wt) in a beaker and mixing until complete dissolution of the crosslinker (approximately 45 minutes).

A neutralizer premix was prepared by mixing the DMEA neutralizer and all the deionized water (17.72%) with agitation for 30 seconds (giving a 3.2% solution of DMEA in DI water).

The acrylic latex was loaded into a vessel and the neutralizer premix was added dropwise and under strong agitation. The mixture was then held for 15 minutes.

The crosslinker premix was added under agitation followed by the solvent under agitation. The lubricant was then added under strong agitation, and then the composition was held for 10 minutes.

### Example 4

The coating composition was then applied to beverage end substrate (Chrome-free, zirconium-pretreated aluminum beverage can end panels (Alloy 51.82/Temper H39) from Elval, the aluminum rolling division of Elval Halcor S. A., Athens, Greece, which had been pretreated with the Permatreat 1903 zirconium-containing pretreatment product from CHEMETALL, Main, Germany) having a beverage can end thickness of 0.2-0.3 mm, using a bar coater to achieve a 10-12 gram per square meter dry film weight. The coated panels were then baked under flash curing conditions for a 12 second dwell time residence at 249° C. PMT (peak metal temperature) in a coil oven. After flash curing process, the coated panels were cooled down at air ambient and basic film properties were checked as indicated in Table 4.

TABLE 4

| | Specification | | | EXAMPLE |
|---|---|---|---|---|
| | target | | STANDARD | 4 |
| Ref sample | | | | |
| Description of the | | | | latex |
| sample | | | | C2WH10246; |
| | | | | eOH/ |
| | | | | eCOOH = 30% |
| Substrate | | | Non-Chrome Aluminium | |
| | | | alloy panels (from Elval) | |
| Filmweight (gsm)/ | 10-12 | gsm | 11.2 | 10.7 |
| Sencon | | | | |
| Cure | 20-8 sec @ | | 12 s, 249° C. PMT | |
| | 232-254° C. | | | |
| Constants | | | | |

| | | | |
|---|---|---|---|
| pH | as STD | 7.1 | 6.4 |

Cured film test Performance

| | | | | |
|---|---|---|---|---|
| MEK DR | taber 2 kg | measure | 40 | 75 |

Fabrication tests

| | | | | | |
|---|---|---|---|---|---|
| Porosity Before | Average | ≤1 | mA | 0.19 | 0.08 |
| pasteurization (mA) | Standard deviation | | | 0.18 | 0.05 |
| Porosity After | Average | ≤2 | mA | 0.76 | 0.84 |
| Pasteurization (mA) | Standard deviation | | | 0.74 | 0.52 |
| (0.17% Dowfax, | | | | | |
| 15 min, 100° C.) | | | | | |
| Feathering 45 mn | Non-Chrome Alu | <0.5 | mm | 0.1 | 0 |
| (85° C., DIW) | panel | | | | |

Pasteurisation tests

| Tap water boiling | Blush | as STD | 8 | 7 |
|---|---|---|---|---|
| (30 min, 100° C.) | Adhesion Gt | | 0 | 0 |

Retort tests

| DI water (90 min, | Blush | as STD | 8 | 8 |
|---|---|---|---|---|
| 121° C.) | Adhesion Gt | | 0 | 0 |
| 2% Citric acid (30 | Blush | as STD | 6 | 6 |
| min, 121° C.) | Adhesion Gt | | 0 | 0 |
| pH 9 NH4OH (30 | Blush | as STD | 7 | 8 |
| min, 121° C.) | Adhesion Gt | | 0 | 0 |

Standard = A non-latex aqueous epoxy-phenolic coil coating composition having commercially acceptable performance for use on the interior of beverage can ends.

The glass transition temperature of the cured film was measured by DSC and determined to be 30° C. The coating demonstrated quite good rivet flexibility after fabrication of easy open beverage can end. The coating exhibited a particularly low porosity value after easy open beverage end fabrication, being less than 5 mA.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the embodiments set forth herein as follows.

What is claimed is:

1. A beverage can end coil coating composition comprising:
an acid- or anhydride-functional acrylic latex comprising an emulsion polymerized polymer;
a carboxyl-reactive crosslinker that is nitrogen-containing and is not derived from formaldehyde; and
optionally, a lubricant;
wherein the coating composition:
(i) includes less than 2 wt-%, by weight of total solids, of a crosslinker derived from formaldehyde, if any;
is free of bisphenol A, bisphenol F, and bisphenol S;
(iii) is optionally free of styrene;
(iv) has a glass transition temperature (Tg), as determined by Differential Scanning calorimetry (DSC), when applied to a cleaned and chrome-free, zirconium-pretreated aluminum panel and cured for 12 seconds to a peak metal temperature of 249° C. to achieve a dried film thickness of approximately 11 (i.e., 10-12) grams per square meter, of 10° C. to 50° C.; and
(v) when applied to a cleaned and chrome-free, zirconium-pretreated aluminum panel and cured for 12 seconds to a peak metal temperature of 249° C. to achieve a dried film thickness of approximately 11 (i.e., 10-12) grams per square meter and formed into a fully converted (typically, 206) standard opening beverage can end, passes less than 5 milliamps of current, while being exposed for 4 seconds to an electrolyte solution containing 1% by weight of NaCl dissolved in deionized water.

2. The coating composition of claim 1, wherein the acrylic latex has an acid number of at least 40 mg KOH per gram of the latex.

3. The coating composition of claim 1, wherein the acrylic latex has an acid number of less than 400 mg KOH per gram of the latex.

4. The coating composition of claim 1, wherein the acrylic latex comprises at least 50 wt-% of an emulsion polymerized polymer, based on the total solids weight of the acrylic latex.

5. The coating composition of claim 1, wherein the acrylic latex is formed from polymerization of an ethylenically unsaturated monomer component comprising two or more different monomers.

6. The coating composition of claim 5, wherein the ethylenically unsaturated monomer component includes at least one ethylenically unsaturated acid- or anhydride-functional monomer, including salt thereof, and at least one (meth)acrylate monomer.

7. The coating composition of claim 5, wherein ethylenically unsaturated monomer component comprises a (meth)acrylate monomer having a Tg of greater than 50° C.

8. The coating composition of claim 5, wherein the ethylenically unsaturated monomer component comprises acrylic acid, ethyl acrylate, and cyclohexyl methacrylate (CHMA).

9. The coating composition of claim 5, which includes less than 1 wt-%, by weight total solids, of a crosslinker derived from formaldehyde, if any.

10. The coating composition of claim 9, which is substantially free of, completely free of, or does not contain a crosslinker derived from formaldehyde.

11. The coating composition of claim 1, wherein the coating composition:
includes lubricant;
includes at least 50 wt-% of the acrylic latex, based on the total solids weight of the coating composition;
includes at least 5 wt-% of one or more organic solvents, based on the total weight of the coating composition; and
includes 30 wt-% to 40 wt-% total -volatile solids content, based on the total weight of the composition.

12. The coating composition of claim 1, wherein the crosslinker has a hydroxyl number of at least 100 mg KOH/g resin.

13. The coating composition of claim 1, wherein the acrylic latex and the carboxyl-reactive crosslinker are present in the coating composition in amounts to provide an excess of carboxyl equivalents in the acrylic latex relative to hydroxyl equivalents in the crosslinker.

14. The coating composition of claim 13, wherein the acrylic latex and the carboxyl-reactive crosslinker are present in the coating composition in a ratio of molar equivalents of carboxyl groups in the acrylic latex to hydroxyl groups in the crosslinker of at least 15:1.

15. The coating composition of claim 13, wherein the acrylic latex and the carboxyl-reactive crosslinker are present in the coating composition in a ratio of molar equivalents of carboxyl groups in the acrylic latex to hydroxyl groups in the crosslinker of up to 6:1.

16. The coating composition of claim 1, comprising at least 0.5 wt-% and less than 30 wt-% of the carboxyl-reactive crosslinker, based on total solids weight of the coating composition.

17. The coating composition of claim 1, which is spray dried and in the form of a powder coating composition.

18. A method comprising:
providing a coating composition of claim 1;
applying the coating composition (e.g., via roll coating) to a substrate comprising a beverage can end steel or aluminum coil;
heating the coated substrate in an oven for 6 to 30 seconds, preferably 8 to 15 seconds, of oven residence time to achieve a peak metal temperature of 200° C. to 260° C.;
and optionally fabricating the coated coil to form an easy open beverage can end.

19. A coated article comprising a beverage can end having an interior or exterior coating, or both formed from the coating composition of claim 1.

20. A method comprising causing the aqueous coating composition of claim to be used on a metal substrate of metal packaging.
